(19) United States
(12) Patent Application Publication
(10) Pub. No.: US 2008/0059273 A1
(43) Pub. Date: Mar. 6, 2008

(54) Strategic planning

(75) Inventor: H. Roy Miller, Toronto (CA)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Dynamic Intelligence Inc., St. Michael (BB)

(21) Appl. No.: 11/894,254

(22) Filed: Aug. 20, 2007

Related U.S. Application Data
(63) Continuation-in-part of application No. 11/709,302, filed on Feb. 21, 2007.
(60) Provisional application No. 60/774,623, filed on Feb. 21, 2006.
(60) Provisional application No. 60/797,413, filed on May 3, 2006.
(60) Provisional application No. 60/879,831, filed on Jan. 11, 2007.

(51) Int. Cl. G06Q 10/00; G06F 17/30

(52) U.S. Cl. 705/8; 705/10

(57) ABSTRACT

Methods and systems for strategic planning of a first transportation organization such as an airline. A multi-player game model (502-530), such as a model simulating the strategy of the first organization and strategies of competitive organizations reacting to moves made by one another, can be used to derive demographics representing potential sales of transportation by the first organization. The first organization derives a feasible schedule for meeting the requirements for transportation specified by such demographics. The scheduling step provides realistic costs and revenues, allowing realistic evaluation of the strategy. The process can be repeated with multiple possible strategies to select a best strategy. Methods of revenue management can include automatically modifying a strategy based on similar multi-player game modeling.

### CROSS-REFERENCE TO RELATED APPLICATIONS

This application is a continuation-in-part of U.S. patent application Ser. No. 11/709,302, filed Feb. 21, 2007, which in turn claims the benefit of the filing dates of U.S. Provisional Patent Application Nos. 60/774,623, filed Feb. 21, 2006; 60/797,413, filed May 3, 2006; and 60/879,831, filed Jan. 11, 2007, the disclosures of all of said applications are incorporated herein by reference.

### FIELD OF THE INVENTION

The present application relates to methods and systems for strategic planning and revenue management in transportation and other operations.

### BACKGROUND OF THE INVENTION

Transportation companies such as airlines face daunting problems in setting policies to govern their operations. For example, airlines generally do not use truly rational processes to select the cities which they serve; to select the policies which they follow in pricing tickets; or to decide whether or not to offer amenities such as in-flight meal service. While conventional tools of market research can aid in estimating impacts of factors such as pricing on potential ticket sales, they offer essentially no information about what impact the sales will have on operating margin. Despite the considerable effort devoted to the problem of running an airline efficiently, it has been estimated that the net profits and losses of all airlines since the invention of the airplane would sum to a net loss. Clearly, there is need for further improvement.

Another daunting problem faced by airlines and kindred transportation companies is the scheduling problem. A schedule which specifies which vehicles and crew are to make specific trips at specific times must take account of the availability of vehicles to be used in the operation and the crews to operate the vehicles, as well as the availability of fixed resources such as airport gates. Each of these resources typically is governed by complex sets of rules which take account of factors such as the need to set aside times for maintenance of aircraft; the differing qualifications of different pilots and crew member duty time limitations set by government regulations or labor union agreements.

As a practical matter, it is impossible to determine an optimum schedule for an airline or other transportation company of any size by conventional mathematical techniques. The problem of deriving an optimum schedule belongs to a class of mathematical problems referred to as “NP-hard,” such that the computational load increases exponentially with the number of aircraft, crew and other elements to be accounted for by the schedule. My own U.S. patent application Ser. No. 11/709,302 (“the '302 application”) describes methods and systems which can calculate a feasible schedule to meet requirements for transportation among numerous city pairs. The preferred scheduling methods and systems can develop a feasible and desirable schedule for an airline having scores or hundreds of airplanes and crews, and serving numerous city pairs, in minutes, using reasonable computer resources.

### SUMMARY OF THE INVENTION

One aspect of the present invention provides computer-implemented methods of strategic planning for a transportation organization as, for example, an airline. The organization using the method is referred to herein as the “first” transportation organization. The method according to this aspect of the invention desirably includes the step of deriving a set of demographics representing potential sales of transportation by the first transportation organization between origins and destinations using one or more multi-player game models by applying an internal strategy of the first transportation organization and predicted external strategies of one or more competitive organizations to information about the market for transportation between the origins and destinations, at least one of the strategies including responses to one or more market conditions. The method desirably further includes the step of developing a feasible schedule for transportation based on the demographics derived in the step discussed above and at least one set of resources associated with the first transportation organization. The schedule is associated with the internal strategy used in the step of deriving the demographics. This step of the method according to the present invention desirably can be performed using the scheduling methods and systems according to the '302 application. Most preferably, the method includes the further step of evaluating a result set as, for example, aggregate contribution to margin (CTM) for the schedule. The result set is also associated with the internal strategy used in the step of deriving the demographics. The method may further include repeating the foregoing using a different internal strategy in each repetition, and selecting the internal strategy associated with the best result set.

The multi-player game desirably includes modeling of the behavior of hypothetical purchasers of transportation, such as passengers purchasing tickets, as they interact with the terms offered by the first transportation organization and competitive organizations, and as the strategies used by the various organizations react to one another over time as sales are made, and thus accurately reflects potential sales using the various strategies. By closely integrating formation of a feasible schedule with the market simulation, the preferred methods according to this aspect of the invention can provide a realistic understanding of the financial results, such as aggregate CTM, which will arise from implementation of each possible internal strategy. The strategies which may be tested in this way can include different selections of origins and destinations to be served by the operation, different pricing strategies, and different selections of non-price elements of value as, for example, how much leg room to provide for each passenger. The ability to accurately model the results of each strategy allows the first transportation operation to select a strategy which stands a realistic chance of returning a profit.

A further aspect of the invention provides methods of revenue management for a first organization offering rights associated with specific times as, for example, transportation such as airline flights. The method according to this aspect of the invention desirably includes selling rights associated with a set of specific times and controlling terms of sale according to an original internal strategy. The method desirably further includes the step, performed during the selling step, of comparing one or more result parameters related to actual sales to a prediction of the one or more result parameters. The method desirably includes a further set of steps to be performed in reaction to a condition, such as the condition where the one or more result parameters varies from the prediction by more than a tolerance amount. The further set of steps desirably includes the step of obtaining at least one new prediction of the one or more result parameters using a multi-player game model by applying one or more possible internal strategies and predicted external strategies of one or more competitive organizations to information about the market, at least one of the strategies including responses to one or more market conditions, selecting a new internal strategy based on the at least one prediction from step, and implementing the new internal strategy with respect to the sale of rights associated with the set of times. The preferred methods according to this aspect of the invention desirably allow the organization to adjust the rules by which it reacts to the marketplace dynamically, as real results are accumulated.

Further aspects of the present invention include computer systems operable to perform methods as discussed above, and computer-readable media having stored thereon instructions for causing a computer system to perform such methods.

### BRIEF DESCRIPTION OF THE DRAWINGS

FIG. 1 is a flow chart schematically depicting certain elements in a method according to one embodiment of the scheduling method of the '302 application.

FIG. 2 is a partial flow chart depicting other elements in the method of FIG. 1.

FIG. 3 is a graph presentation of historical passenger loading data.

FIG. 4 is a diagrammatic representation of certain predicted passenger loading data abstracted from the data of FIG. 3.

FIG. 5 is a partial flow chart depicting further steps of the method shown in FIGS. 1 and 2.

FIG. 6 is another partial flow chart depicting one of the steps of FIG. 5 in greater detail.

FIG. 7 is a further partial flow chart depicting another step shown in FIG. 5 in greater detail.

FIG. 8 is yet another partial flow chart depicting a further step shown in FIG. 5 in greater detail.

FIG. 9 is a diagrammatic graph of expected passenger loading versus departure time.

FIG. 10 is a diagrammatic view of a process used in the method of FIGS. 1-9.

FIG. 11 is a further partial flow chart depicting certain steps used in the method of FIGS. 1-10.

FIG. 12 is yet another partial flow chart depicting one of the steps shown in FIG. 11.

FIG. 13 is a diagrammatic flow chart depicting a process in accordance with a further embodiment of the scheduling method of the '302 application.

FIG. 14 is a schematic representation of a computer system and transportation system.

FIGS. 15 and 16 constitute a flow chart representing a method of strategic planning according to one embodiment of the present invention.

FIG. 17 is a graph illustrating a booking curve function used in the method of FIGS. 15-16.

FIG. 18 is a flow chart representing a method of revenue management according to another embodiment of the present invention.

### DETAILED DESCRIPTION

Because the scheduling process according to the '302 application forms a highly desirable component of preferred methods according to the present invention, the scheduling methods and systems are described herein.

The Scheduling Methods and Systems

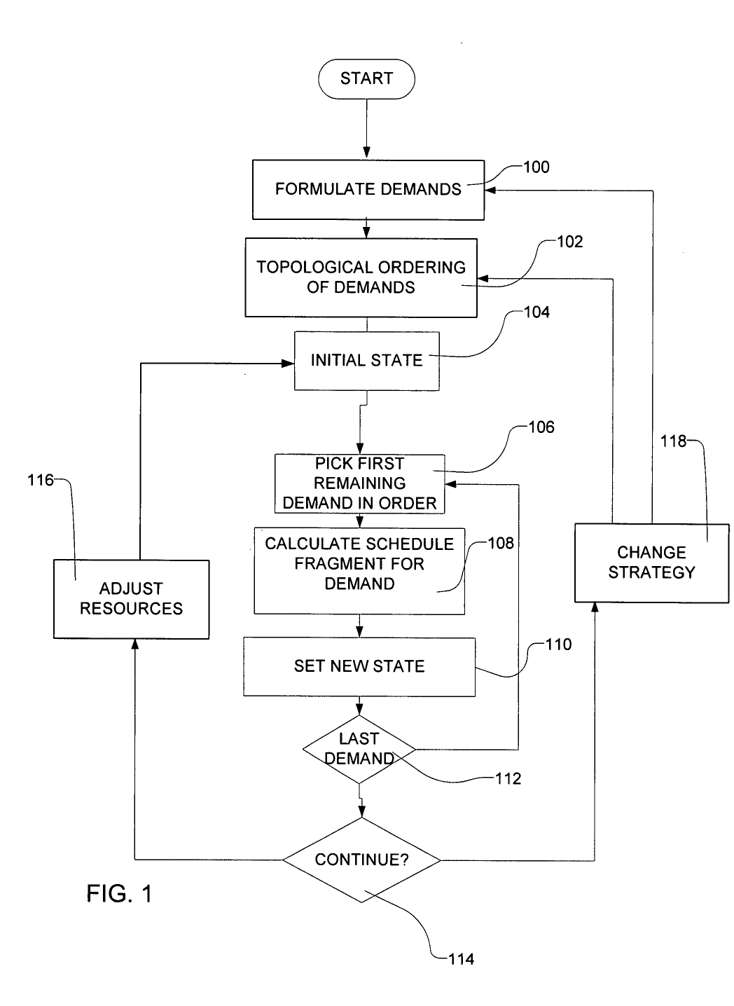

A scheduling process according to one embodiment is shown in general form in FIG. 1. The process starts by formulating a set of demand nodes, i.e., demands for transportation operations associated with particular dates and times in the future. In the example discussed herein, the demand nodes represent demands for passenger airline flights, but other transportation operations can be treated similarly. In addition to the date, departure time, origin, destination, and expected number of passengers in each class, the data defining each demand node most desirably includes additional data associated with the results to be achieved by meeting the demand, as for example, an ideal contribution to operating margin (“CTM”) or other financial result of the airline from an operation meeting the demand using the best possible aircraft at the exact time specified in the demand; expected revenue per passenger in each class of service; an indication as to whether the operation denoted by the demand node serves as a feeder to route traffic to other operations in the system; and other factors discussed below. The system can provide usable results with demand nodes formulated according to any reasonable scheme. However, it is highly desirable to formulate the demands according to a process such as the demand node formulation process further discussed below.

In the next stage 102 of the process, the demands are placed into an order, referred to herein as a “topological” order. This order defines the order in which the demands will be treated by the system in the scheduling operation. The ordering step is performed principally by sorting the demands according to one or more sort keys, each such sort key being based on one or more elements of the data associated with the demand nodes. For example, the demand nodes may be sorted by departure date and time, with or without other factors such as expected contribution to CTM. Alternatively, the origin and destination of the demand nodes may be used as sort keys, so that flights between particular cities are placed higher in the order.

Once the demands have been placed into the order at step 102, the system starts with an assumed initial system state. This system state includes data defining availability of resources which are required to perform the transportation operations. These resources include mobile resources such as aircraft or other vehicles used in the operation; and crew members, as well as fixed resources which may be associated with points of origin or points of destination, as for example, airport gates. The system then treats the demands in order according to the topological ordering assigned at step 102. Thus, at step 106, the system simply picks the first demand at the top of the ordered list, and works with that demand in step 108 to calculate a schedule fragment for that particular demand. The process of calculating the schedule fragment involves selection of resources to be applied to meeting the demand in such a way as to produce a feasible result, and desirably, the best attainable result given the state of the system. For example, the system may seek to select a particular aircraft and crew which will yield the best operating result, such as the best CTM, for the particular segment. It should be appreciated that optimization of the schedule fragment for a particular operation is a relatively simple problem; the number of possibilities for a given demand node is bounded by the number of available resources in the system, and does not grow with the number of demand nodes. The process of calculating the schedule fragments may include adaptation. As discussed below, the term “adaptation” as used herein refers to adjustment of the initial assumptions applied in a selection or optimization process. For example, while a demand may specify a flight departing from Cleveland at 6:00 p.m. with capacity for 150 passengers, the process of setting a schedule fragment includes examining the results which could be achieved by departing at slightly later times, or with a smaller aircraft, or both.

Once the system has selected a feasible and, most preferably, optimum set of resources to be applied to the particular demand under consideration, resources are committed to the particular demand being treated. This results in setting a new system state at step 110. Thus, the list of which aircraft are available at which times is modified to indicate that the aircraft assigned to the demand treated in step 108 can no longer be considered available on the date and time considered in step 108. Similarly, the crew members assigned to the particular demand treated in step 108 will no longer be available, and so on. The system then cycles back to step 106, whereupon the system treats the next demand now at the top of the list. Thus, in each cycle, the system considers one demand and tries to find a feasible set of resources for that demand, and most desirably, an optimal set of resources. This process continues until all of the demand nodes have been processed, at step 112.

As stated above, during calculation of the schedule fragment for each demand, the system evaluates a result function, most often a financial result such as CTM associated with the set of resources assigned to meet the demand node. The system also records this result as the expected result for the schedule fragment and aggregates this result with the results associated with all other previously calculated schedule fragments to yield an aggregate expected result, such as aggregate CTM for the schedule as a whole. The expected result such as CTM at this stage of the operation is more accurate than the ideal CTM of the original demand node. The expected result after calculation of the schedule fragment reflects results which can be achieved with the available resources. In some cases, the system may not be able to find a feasible set of resources, and in that case, may return a result indicating that the demand will not be met. The system also can keep track of these instances.

When the system has processed the last demand at step 112, the system has developed a full schedule defining allocations to resources for all of the demands, or at least that subset which can be served by the available resources and which are not excluded by other criteria discussed below. The number of calculations to be performed in a complete cycle through steps 106-112 to produce a complete schedule is limited and does not increase exponentially with the size of the operation to be scheduled. All of the calculations required to complete a full schedule can be performed in a few minutes or less on a conventional personal computer programmed to perform the operations discussed herein. Because the scheduling operation can be performed rapidly, the assumptions used in developing a schedule can be changed, and the scheduling process can be repeated. As indicated at step 114, the computer system or a manual operator may observe the aggregate result from the scheduling operation, for example, by evaluating the aggregate CTM, the numbers of demands which are not met or the like, and make a decision to repeat the scheduling process. That decision may include a decision at step 116 to adjust the level of resources made available for the scheduling operation, as for example, the number of aircraft or crews, and repeat the scheduling operation starting at step 104 and continuing until the whole additional schedule has been completed.

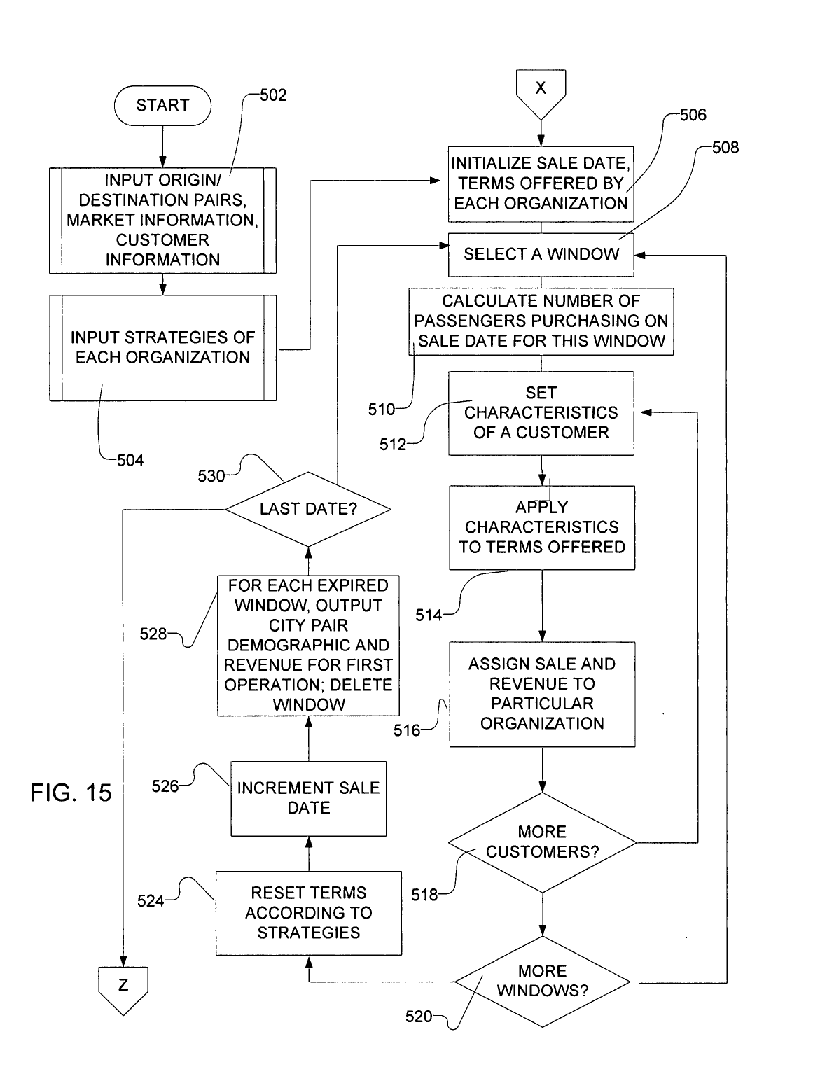

Because it is feasible to calculate schedules rapidly, this cycle can be repeated over and over again, until an optimum level of resources which returns the best result, such as the highest CTM or the fewest demands not met, is found. Alternatively or additionally, the system or a manual operator may instruct the system to change either the assumptions used in formulating the demands in step 100, or the sorting order applied in the topological ordering step 102. For example, as discussed below in connection with FIGS. 15-18, scheduling system may be used in conjunction with a strategic planning module which applies a game theory to test various fare levels, levels or ancillary services or other factors versus known information concerning competition. Different assumptions applied in the game theory yield different estimates of market share and hence different numbers of expected passengers and different expected revenue per passenger in the demand nodes. In the change strategy step 118, the game theory system (not shown) may be instructed to try a different assumption concerning fares to be charged or services to be offered by the airline using the scheduling system and the responses of competitors to those fares, and which results in different predictions of passenger loading, and hence different demands at step 100. Different estimates of market share may be applied to various portions of the demand calculations as, for example, different market shares along routes served by different competitors. The sort keys and sorting order applied in the topological ordering step 102 also may be varied. Thus, essentially any element of the strategy used by the airline can be changed. Here again, because the scheduling system can generate a complete schedule for months of operation in a few minutes, it is feasible to calculate schedules for numerous strategic assumptions, and thus find the best strategic assumptions.

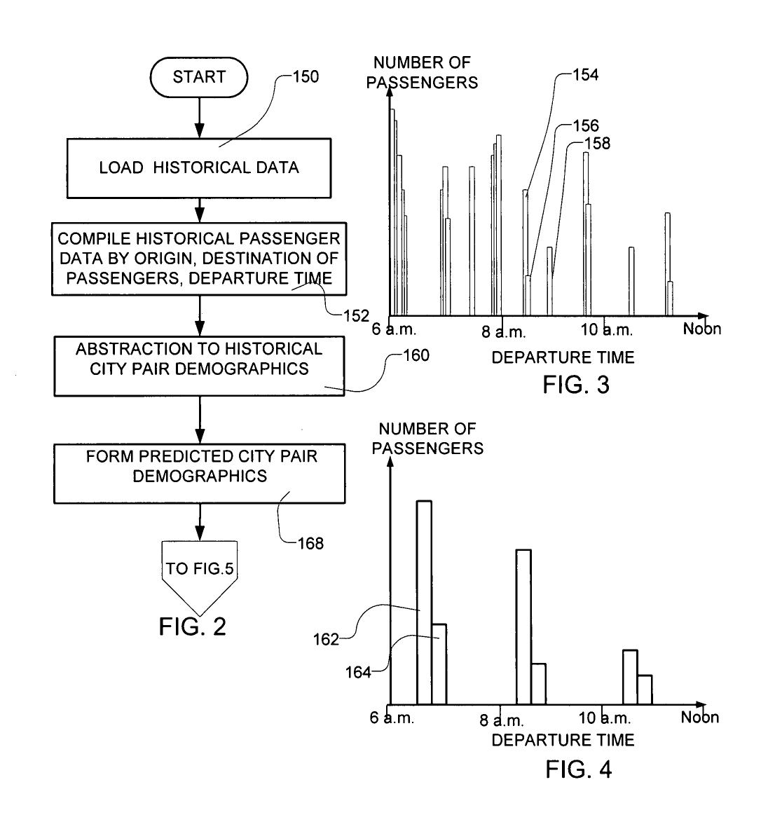

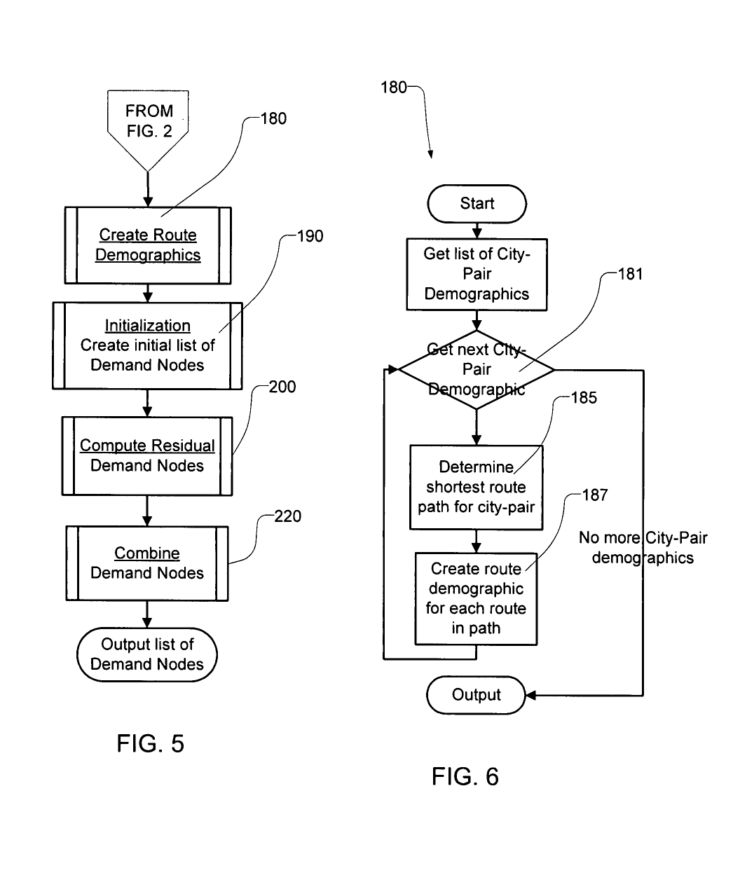

A process for formulating the demands (step 100 of FIG. 1) is shown in greater detail in FIGS. 2-9. The process begins by loading historical data describing sales of tickets by all carriers serving the cities to be served by the airline. This passenger data typically is provided in the form of passenger name records or “PNRs,” each of which reflects travel by an individual passenger. Each PNR typically reflects the passenger's origin and destination; the price paid for transportation between the origin and destination; the class of service as defined by the carrier which carried the passenger. PNR data is commercially available within the airline industry. Desirably, at least one year of historical data is used.

In the next stage 152 of the process, the system compiles historical data for each pair of origin and destination cities. The system may make separate compilations for different sets of days during the period treated. For example, the system may compile a set of data for each origin and destination with respect to all weekdays; or alternatively, a set of data for all Mondays during the historical period in question, another set of data for all Tuesdays during the same period, and so on. Each historical period desirably is less than a full year as, for example, a month, so that sets of data compiled for different periods such as different months can be compared with one another to detect patterns of seasonal variation. Also, sets of data compiled for different historical periods can be compared with one another to detect growth trends in travel between particular origin and destination cities. For example, if more than one year's worth of data is available, the number of passengers carried between the particular origin city and destination city on weekdays in February of the latest year can be compared with the comparable number for February of the prior year to derive an estimate of year-to-year growth. The compilation for each set of days during the historical period includes data concerning the number of passengers departing at each particular departure time in each class of service offered by the various carriers serving the cities during the historical period in question, and also includes data about the average fare paid by passengers for each such class of service.

The departure time data reflects passenger behavior with the schedules offered by the airlines serving the origin and destination during the historical period in question. This data is depicted graphically in FIG. 3. For example, bar 154 represents the number of passengers traveling in economy class on a flight of airline A departing at 8:30 a.m., whereas bar 156 represents the average number of passengers carried in first class on the same flight of airline A, whereas bar 158 represents the average number of passengers carried on a single class flight of airline B departing at 8:45 a.m.

In a further step 160 of the process, the historical information is abstracted by lumping together the passengers departing during a defined time interval referred to herein as a window, as for example, a particular one-hour or two-hour window during the day, and the classes of service offered by the various airlines are mapped to the most nearly comparable classes of service to be offered by the airline being scheduled. The system thus forms a historical city-pair demographic for each class of the airline being schedule for each window. For example, as shown graphically in FIG. 4, bar 162 represents the average number of passengers who departed from the particular origin for the particular destination on an average weekday and purchased tickets in classes of service on all carriers corresponding roughly to the economy class of the carrier being scheduled. Similarly, bar 164 represents the average number of passengers for first class during the same window on an average weekday. Although the compilation and abstraction processes 152 and 160 are shown as separate processes for clarity of illustration, these processes may overlap. For example, as each PNR record is examined, the class of service may be translated from the class of service of the carrier actually used to the average class of service of the carrier being scheduled.

In effect, each window represents a market of potential passengers which is distinct, to some extent, from the market represented by other windows during the day. The sizes of the windows may be varied for different city pairs by manual or automatic selection depending on factors such as the number of flights serving the city pair. For example, where two cities are connected by only two flights per day, the window size may be 12 hours; where cities are connected by dozens of flights per day (such as New York and Chicago), the window size may be less than an hour.

The system may assign an arbitrary departure time within the window used in the abstraction process, as for example, the center of the window. More preferably, the system computes the mean departure time of the passengers included in the demographic based on the historical departure times incorporated into the demographic, and assigns that mean time as the departure time of the city pair demographic. The system may also obtain a measure of the time variance in the demographic, i.e., a measure of the relationship between time within the window and number of passengers.

The system also computes an average historical fare in terms of the classes of service to be offered by the carrier being scheduled. Thus, as the class of travel for each passenger name record is matched to a comparable class on the carrier being scheduled, a historical fare paid by the passenger in question is taken as a fare which the same passenger would have paid for travel in the comparable class in the carrier being scheduled. These fares are averaged over all of the passengers included in the demographic to yield an average historical fare associated with the class and window.

Thus, at the conclusion of the compilation and abstraction processes, the system has a set of historical city-pair demographics for each pair of origin and destination cities. Each such historical city pair demographic includes a departure time, a number of passengers, and an average fare for each class of service of the carrier being scheduled, and may include additional data such as a measure of variance in the departure time.

These historical city pair demographics can be converted to predicted city pair demographics in a further step 168 of the process. As discussed above, the historical demographic for each city pair represents passengers carried by all carriers. The number of passengers in each historical city pair demographic is multiplied by a predicted market share for the airline being scheduled in the particular market represented by the demographic. For example, if the historical city pair demographic indicates that 600 coach-class passengers and 100 first-class passengers depart from Seattle for New York on an average weekday between 6:00 p.m. and 8:00 p.m., and the estimated share of market achieved by the carrier being scheduled is 20%, then the predicted city pair demographic will indicate that the airline may expect 120 coach-class passengers and 20 first-class passengers. Similarly, a growth factor may be applied to take account of year-to-year increase (or decrease) in traffic between the origin and destination cities. Further, a predicted average fare for each class of service which the airline will realize is included in each predicted city pair demographic. The prediction of market share as a function of average fare can be made intuitively, but preferably is made by applying techniques such as game theory which account for competitive behaviors in the marketplace. Alternatively, historic market share and historic fare data can be used, based on the assumption that none of the airlines serving the market will change its pricing strategy. More preferably, however, the predicted city pair demographics are derived from the modeling system discussed below with reference to FIGS. 15-17.

The predicted city pair demographics resulting from step 168 are converted to demand nodes, i.e., individual demands for transportation between origins and destinations along routes served by the airline being scheduled by the process shown in overview in FIG. 5. In the first step 180 of this process, each city pair demographic is converted to a route demographic by steps shown in greater detail in FIG. 6. The process of FIG. 6 assumes that the airline has determined which city pairs will be served by direct, nonstop flights between cities, and hence has a list of directly connected cities. Each pair of directly connected cities is referred to herein as a “route.” The system gets a list of city pair demographics and then treats each city pair demographic in order. At step 185, the system selects the shortest path through all of the available routes which connect the origin city of the city pair demographic with the destination city. For example, the system may examine all of the routes which have their origins at the origin city of the city pair demographic and determine if any of those routes have their destinations at the destination city of the city pair demographic. If so, that route is a direct, nonstop route, and hence, is shortest. If not, the system may examine the destination city of each route having its origin at the origin city of the city pair demographic and select a set of cities which constitute the destination cities of those routes. The system may then consider each such destination in turn, and see if there is a route having its origin at such destination city and its destination at the destination of the city pair demographic. If so, the system records the aggregate length combination of two routes and continues such examination until all such combinations of two routes have been found. The system then considers the available combinations of two routes and selects the combination which has the smallest total length. If no two-route combination is found, the system may then search for a three-route combination in a directly analogous manner.

In a variant of this approach, the system may treat certain cities as hub cities, so that if there is no direct, single route path, the system will seek to construct two-route and three-route paths using flights passing through hub cities. This greatly reduces the number of possibilities to be considered in formulation of two-route and three-route paths.

In a further variant, the system may exclude routes running in the wrong direction from the origin city or from a hub city, i.e., routes for which the destination city of the route is further from the destination city of the city pair demographic than the origin city of the route. This further limits the number of routes to be considered in finding two-route and three-route paths. The length of each route considered in this process may be the actual geographic mileage between the cities, or may be a score based on geographic mileage and other factors such as landing fees or congestion at particular airports.

Once the system has found the shortest route path for a particular city pair demographic, the system creates a route demographic for each route in this shortest path at steps 187. If the shortest route happens to be a single-route path, i.e., a direct, nonstop route, then the route demographic is identical to the original city pair demographic. However, if the path is a multi-route path, the system constructs a first route demographic having its origin at the origin city of the city pair demographic, having destination as the destination of the first route, and having a departure time as the departure time of the city pair demographic. The expected revenue per passenger for the first route demographic is a portion of the expected revenue per passenger. The proportion of expected revenue may be done on the basis of route length, i.e., the expected revenue for the first route may be the expected revenue for the city pair demographic divided by the total length of all routes in the path and multiplied by the length of the first route itself. The system also creates a route demographic for the second route in the path. This route demographic has its departure city as the destination city of the first route, its destination city as the destination city of the second route, and its departure time equal to the departure time of the city pair demographic, plus the expected flying time along the first route and an allowance for transfer time. Here again, the expected revenue for the second route is a portion of the expected revenue per passenger for the city pair demographic as a whole, calculated by length as discussed above for the first route. In the case of a multi-route path, the route demographic for each route in the path may be annotated to indicate that the route is either a feeder route (where there is a subsequent route in the path), or a recipient route (where there is a previous route in the path), or both.

Once route demographics have been set for all of the routes in the path, the system returns to step 181 and repeats the process of steps 185 and 187 for the next city pair demographic, until all city pair demographics have been treated and converted to route demographics. Each route demographic identifies its dates of applicability in the same manner as a city pair demographic. For example, a route demographic derived from a city pair demographic applicable only to Mondays in February would, likewise, also be applicable only to Mondays in February.

After the route demographics have been formed, they are used in the next step 190 of the process shown in FIG. 5 to create an initial list of demand nodes. Each route is taken in turn. For each route, a list of route demographics having origin and destination corresponding to the route in question is compiled from the route demographics formed in step 180. The list of route demographics for each route is converted into a set of demand nodes for each day of applicability of the route demographic in question. For example, a route demographic applicable to Mondays in February would be converted into a demand node for the date corresponding to the first Monday in February, another demand node for the date corresponding to the second Monday in February, and so on. The system can also take account of a priori or intuitive knowledge available to the operator. For example, if historical data is compiled for weekday flights, and the operator is aware that a particular date will be a religious holiday at the origin or destination, the system can reduce the expected number of passengers for that particular date. After all route demographics corresponding to a particular route have been processed, the system picks the next route and processes the route demographics for that route in the same way. This process continues until all of the route demographics for all of the routes have been processed.

At this point, there is an initial list of demand nodes for each route. Each such demand node includes all of the characteristics of the route demographic, such as the origin, the destination, a departure date and time, an expected revenue per passenger for each class, and an expected number of passengers in each class.

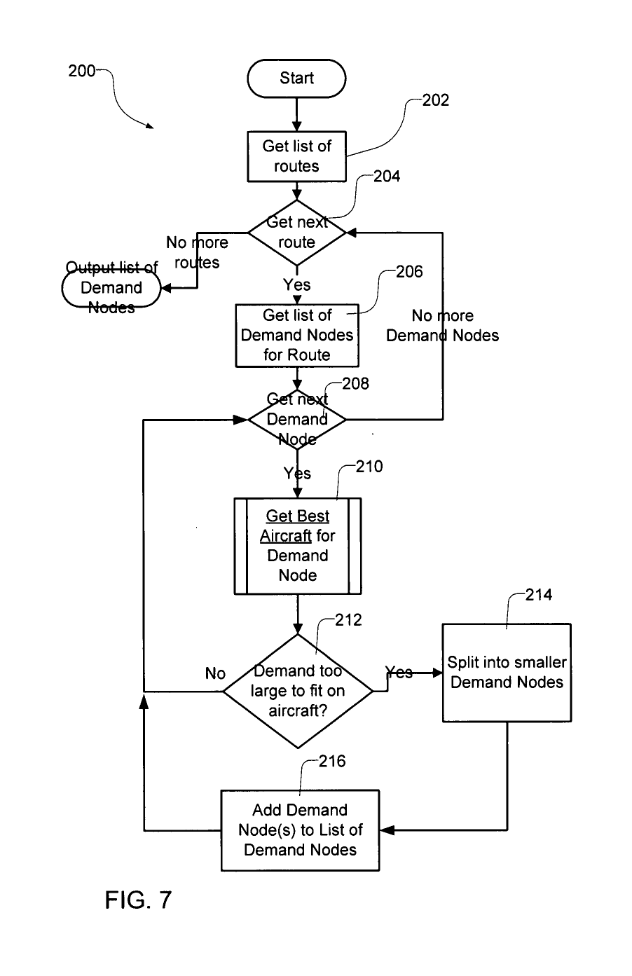

In the next stage 200 of the process, the system examines the demand nodes in the initial list as shown in greater detail in FIG. 7. This examination begins with a list of routes at step 202, and gets each route in turn at step 204. For each route, the system obtains the list of demand nodes for the route at step 206. This list need not be in any particular order. Once the list of demand nodes for a particular route has been retrieved, the system starts with a first demand node in the list. The system takes the first demand node in the list at step 208 and processes the demand node to select the best aircraft for use in a flight meeting that demand node, i.e., a flight from the origin to the destination with the expected number of passengers. The system examines all of the aircraft types used by the airline being scheduled, and selects the type of aircraft which, if flown from the origin to the destination city with the number of passengers specified in the demand node, will yield the largest contribution to margin. At this stage of the process, the selection of a “best” aircraft type is made without consideration of whether an aircraft of this type will actually be available at the time and date specified by the demand node, and without consideration of costs which might be incurred in making the aircraft available at such time and date, as for example, ferrying the aircraft from a distant location. Thus, the contribution to margin characterized in this stage of the process presents an upper bound on the return to be expected from meeting the demand node.

In the next stage 212 of the process, the system compares the number of passengers specified in the demand node against the number of passengers which can be carried by the best aircraft selected at step 210. If the number of passengers specified in the demand node is less than or equal to the capacity of the selected best aircraft, the system marks the demand node as processed, annotates the demand node with an expected contribution to margin, and returns to step 208 to process the next demand node. However, if the number of passengers specified in the demand node is greater than the carrying capacity of the selected best aircraft, the system erases the original demand node from the list and splits the demand node into two smaller demand nodes at step 214 and adds these smaller demand nodes to the list of demand nodes for the route, whereupon the system again returns to step 208 to get the next unprocessed demand node. One of the new smaller demand nodes may constitute the next demand node to be processed. The smaller demand nodes created from a large demand node are identical to the original demand node, but each of the new smaller demand nodes has one-half of the number of passengers specified in the original demand node. The additional demand nodes have the same departure time as the original demand node. The additional demand nodes are processed in the same manner as the other demand nodes in the list. Thus, a very large demand node may be split into two demand nodes on the first pass through step 212. When each of these smaller demand nodes is processed, one or more may be split again into still smaller demand nodes. Also, when such a split, smaller demand node is processed at step 210, the best aircraft selected for that demand node may be different from the best aircraft selected for the original large demand node.

The process continues in this manner until all of the demand nodes for the route (including any smaller demand nodes resulting from splitting at step 214) have been processed, whereupon the system gets the next route at step 204 and the list of demand nodes associated with the new route, and repeats the same process. This continues until all of the routes have been processed in the same manner.

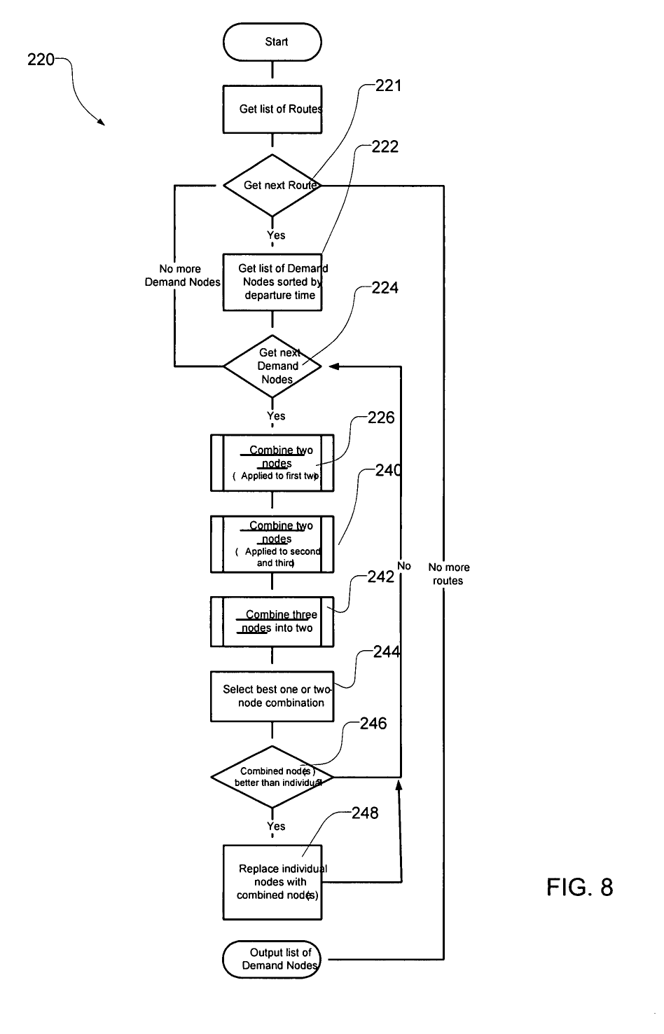

The resulting output list of demand nodes is passed to a further step 220 (FIGS. 5 and 8). In this step, the system examines the list of demand nodes for each route and determines whether a better expected CTM can be found by combining demand nodes with one another. This step selects a particular route from the list of routes and sorts all of the demand nodes from step 200 (FIG. 5) by departure time. At step 224 of step 220 (FIG. 8), the system selects a set of the three earliest demand nodes in the sorted list. The system then attempts in step 226 to create a combined node from the first two of the three selected nodes.

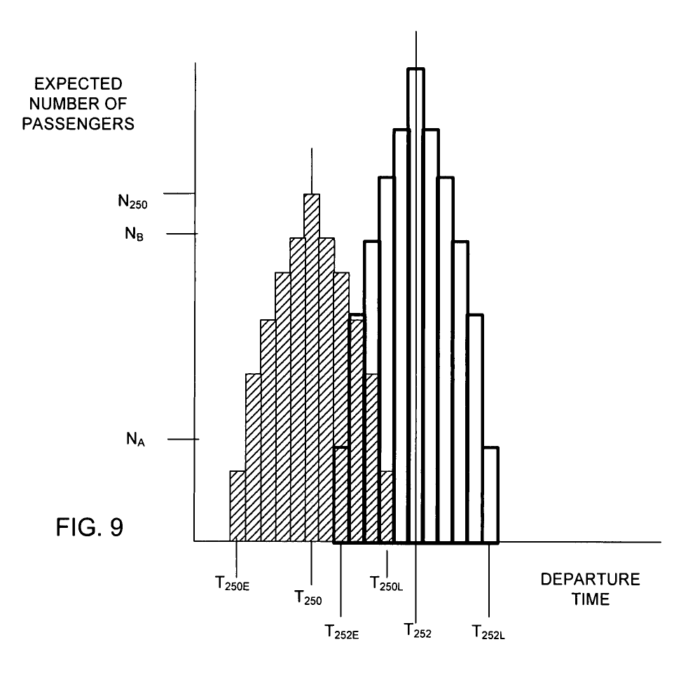

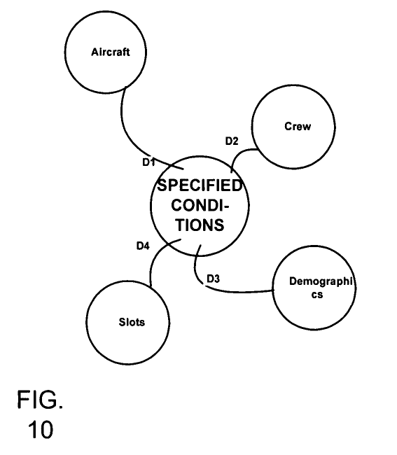

This process computes a range of times for each of the two demand nodes. This range of time for each demand node is based on an estimate of the manner in which passenger loading will vary with time if a flight is shifted in time from the time specified in the demand node. As represented graphically in FIG. 9, the variance in passenger load with departure time for a demand node 250 may be represented by a step function shown by the cross-hatched bars. The step function has its maximum value N₂₅₀, equal to the number of passengers in the demand node, at the original departure time T₂₅₀ of the demand node, and having progressively lower values for earlier and later departure times. The significance range for the demand node may be taken as the earliest and latest time for which the step function has a value greater than some arbitrary number of passengers. The step function may be based on an overall assumption for the system as a whole, or alternatively, may be selected based on a priori knowledge associated with particular routes. For example, demand nodes serving known business destinations such as New York City or Washington, D.C. may be assigned a narrow, steeply declining step function to reflect an assumption that business travelers generally are on a tightly constrained schedule, whereas demand nodes having a destination or origin at a resort location such as Orlando, Fla., may be assigned a considerably broader variance based on the assumption that vacation travelers are relatively insensitive to schedule.

In yet another embodiment, an estimate of the variance of passenger load with departure time may be obtained from the historical data used to generate the historical passenger data and city pair demographics. For example, if the historical passenger data shows substantially equal numbers of passengers departing at many different times, widely spaced around the mid-point of the window used in the abstraction process (step 150), the city pair demographic may be assigned a large variance, and this variance may be assigned to each route demographic derived from such city pair demographic in step 180 and carried forward into each demand node created from the route demographic. Additionally, the variance for a particular demand node may be single-sided or asymmetrical about the departure time of the demand node. For example, if a particular demand node is annotated with an indication that this demand node is derived from a route demographic which represents the second or subsequent route demographic in a multi-path route (step 180), the variance or step function can be arranged to decline gradually for departure times after the original departure time of the demand mode, but may drop abruptly to zero passengers for all departure times prior to the original departure time of the demand node, reflecting the reality that if a connecting flight departs early, the passengers from the earlier flight in the path will not be available.

The function relating number of passengers to time for each demand node has a range of significance bounded by the earliest and latest times at which any appreciable number of the passengers represented by the demand node would be willing to travel along the route. For example, the step function for demand node 250 has a significance range from time T_{250E} to time T_{250L}. Another demand node 252 having departure time T₂₅₀ has a variance function represented by unshaded bars in FIG. 9, with a significance range from T_{252E} to T_{252L}. The system examines the significance ranges of the two demand nodes and determines if the significance ranges overlap. If they do not overlap, the attempt to combine these two demand nodes is abandoned, and step 226 is complete. However, if these significance ranges overlap, the system selects a set of possible departure times for a combined demand node. The earliest possible departure time is either the earliest time in the range of times encompassed by the overlapping significance ranges, or the original departure time of the earlier demand node, whichever is later. The latest possible departure time is the latest time encompassed by the overlapping significance ranges of the two demand nodes, or the departure time of the later demand node, whichever is earlier. For example, the significance ranges of demand nodes 250 and 252 overlap from time T_{252E} to time T_{250L}. Thus, the earliest possible departure time for a combined node would be T_{252E} and the latest possible departure time would be T_{250L}. In reality, overlapping significance ranges for two demand nodes on the same route and same day indicate that a flight along the route departing during the range of overlap would attract some passengers associated with the earlier demand node and some passengers associated with the later demand node. The system also calculates one or more intermediate possible departure times between earliest and latest possible departure times. For example, the system may calculate one such intermediate departure time as the mid-point between the earliest and latest possible departure times.

For each possible departure time, the system determines the number of passengers expected for such departure time. The system evaluates the step function for each demand node at the possible departure time and adds the value of the step functions for both demand nodes for the particular departure time to yield an expected number of passengers for a combined node operating at that possible departure time. For example, the expected number of passengers for a flight departing at time T_{252E} is the sum of N_{A} and N_{B} (FIG. 9).

The system then calculates the best aircraft for the demand node at each possible departure time and calculates the CTM for that possible departure time. In the combining step, if the expected number of passengers exceeds the capacity of the best aircraft, the expected number of passengers is set equal to the capacity of the aircraft. The system compares the CTMs for the possible departure times and selects the best one as the result of combining the first two demand nodes, whereupon step 226 terminates. The system then attempts to combine the second two demand nodes at step 240 in exactly the same manner and attempts to combine all three of the selected demand nodes at step 242. The process of combining three demand nodes may assume that these demand nodes are to be combined into two demand nodes having two different departure times, and uses a plurality of possible departure times within the range from the departure time of the earliest or first demand node to the departure time of the latest or third demand node and calculates combined passenger loading at each possible departure time based on the step functions of the three selected demands, and once again selects the best aircraft and computes CTMs for the best aircraft for each possible departure time. The best aggregate CTM for the two demand nodes is output as the result of step 242.

At step 244, the system compares the CTMs resulting from the two-node combinations of steps 226 and 240 and the three-node combination of step 242, and picks the best of these CTMs and outputs a result including the possible departure time, the expected CTM for the combined nodes, and the identity of the nodes which will combine to yield the combined nodes, i.e., the first two, the second two, or all three of the nodes considered. At step 246, the system compares the CTM for the combined node output by step 244 with the sum of the CTMs for the individual nodes which were used to form the combined node. If the combined nodes yields CTM higher than the sum of the CTMs for the individual modes, the system branches to step 248 and replaces the individual nodes used to form the combined output node with the combined node or nodes, and then returns to step 224. If not, the system returns directly to step 244 without replacing the individual nodes. At step 224, the system gets another set of three demand nodes, including the latest demand node in the set previously processed and the two succeeding demand nodes. The system then treats this new set of demand nodes in the same manner. This continues until there are not more demand nodes to be processed, whereupon the system branches back to step 221 and selects the next route, which is processed in the same manner. This continues until all of the routes have been processed.

In this combination process, the system may reverse some of the splits made at substep 214 (FIG. 7) of the residual demand process 200. For example, if a very large demand node was split into two demand nodes, the two demand nodes may be combined back again into a larger demand node at step 226 or step 240.

At this point in the process, the step of formulating demands (step 100 in FIG. 1) is complete. The system then places the demand nodes into an order, referred to herein as a topological order. This is done by sorting the demands according to one or more sort keys. A sort key may include any characteristics of the demands. One simple sort key consists of the date and departure time specified in the demands, so that the demands are placed in chronological order. However, other sort keys may be used, as for example, sorting by expected CTMs, so that the most profitable flights are first in the topological order, or sorting by length of routes, so that the long-haul demands are scheduled first or so that short-haul demands are scheduled first. Also, an airline may wish to give priority to flights between designated hub cities so that demand nodes having hub cities as origin and destination cities are treated first. As noted above, a route demand may be marked as a feeder route demand of a multi-route path, and the demand nodes resulting from the feeder route demand are similarly marked. This marker may be used a sort key so that feeder demand nodes are treated first. In a further variant, these and other characteristics of demand nodes may be assigned weighting factors, and a composite sort key may be calculated based on plural characteristics of each demand node, weighted by such factors. The choice of sort key will influence the results achieved in scheduling to some degree. However, in practice, it has been found that simply sorting by departure date and time works as well or nearly as well as more complex schemes.

The system maintains a database of the resources needed to perform the operations to be schedule. For an airline, these resources include airplanes and crew members, both of which are mobile, as well as passenger loading gates at particular airports. The database includes information about the characteristics of each resource, and also contains information concerning the status of each resource at each time in the future during the duration of the schedule being generated. For an airplane, the characteristics typically will include the type of airplane; its seat capacity in each class of service; its maximum range (which may be stated as a maximum block time); and the cost of using the airplane, typically stated as a cost per flying hour. The status information for an airplane for each time in the schedule would include location, as for example, parked at a particular airport or en route; an indication as to whether the airplane is out of service for maintenance; and information about the operating history of the airplane, such as the number of operating hours and calendar days since last scheduled maintenance check and since last major overhaul. For a crew member, characteristics would include qualifications to serve on particular types of aircraft and home base. The status information for each time would include information such as whether the crew member is on-duty or off-duty; the location of the crew member at his home base, or at some other airport, or en route; and the number of hours or flights since the crew member came on duty, the number of hours of duty time accumulated in each month and year, and any other data pertinent to calculation of the crew member's availability for flights under pertinent government regulations, union contracts, or airline personnel policies. The characteristics of a gate include identification of an airport where the gate is located, and may also include types of aircraft which can be accommodated at particular gates. A gate also may have associated with it an occupancy cost such as may be imposed for late departure of an airplane. The status for a gate typically is simply an indication of whether the gate is occupied or unoccupied at each interval during the schedule.

The database is set to an initial state which represents the expected state of the various resources at the beginning of the schedule.

The system takes the demand nodes in the order set by the topological ordering step and seeks to calculate a schedule fragment for each demand node. Each schedule fragment includes the origin and destination of the demand node, and specified conditions for the flight operation which will satisfy the demand node. These conditions include a particular aircraft, particular crew members, and a particular gate. The specified conditions are selected so that they are feasible, i.e., so that the aircraft exists and is not otherwise occupied; so that the slot or gate is available; and the crew members are qualified and available. The system also seeks to specify conditions for the schedule fragment so that a result function representing an expected outcome for flying the flight according to the conditions, meets a criterion. The most common result function is the contribution to margin expected from the operation, and the system seeks to maximize the expected contribution to margin from the operation.

The problem of selecting conditions to be specified in a schedule fragment can be understood with reference to FIG. 10. The distance D₁ between aircraft and the specified conditions represents a negative contribution to margin or cost associated flying the aircraft from the origin specified in the demand to the destination specified in the demand, and also includes a cost, if applicable, for repositioning the aircraft from another airport if necessary. The distance D₂ represents the cost of providing the crew, including both direct costs per hour and extraordinary costs such as relocation of crew members, overtime paid to crew members, and the like. The distance D₃ between the specified conditions and the demographics incorporated in the demand node represents negative effects on revenue resulting from specifying a departure time different from the departure time specified in the demand node, as for example, where the specified aircraft is not available at the departure gate at the time specified in the demand node. Distance D₃ also includes any loss of revenue resulting from specifying an aircraft which is too small to accommodate the expected passenger load. Distance D₄ represents a cost associated with the slot or gate used at the origin airport and destination airport. The system seeks to select conditions such that the sum of D₁-D₄ is at a minimum given the constraints imposed by the current state of the database of resources, i.e., availability of resources as indicated in the database. The minimization or maximization need not be a strict mathematical minimization or maximization. Stated another way, the system need not consider every possible alternative, but may in fact consider only some alternatives consistent with available resources so as to reach a local minimum or maximum. However, it is generally feasible to consider most or all available resources.

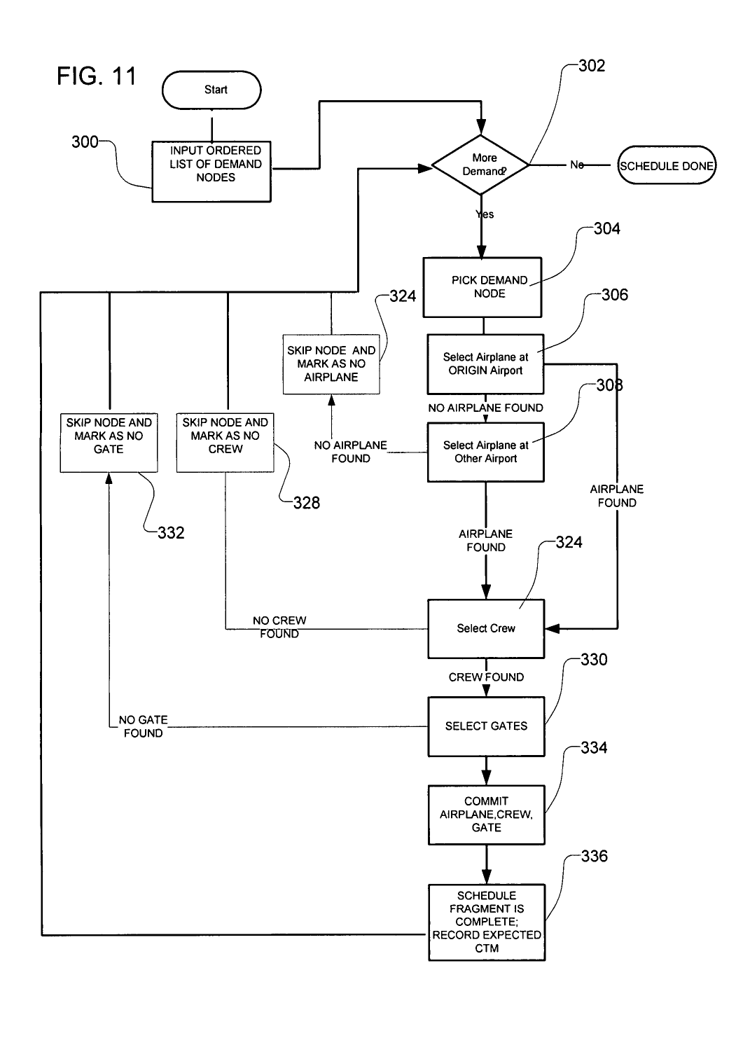

One implementation of the process used to select conditions for schedule fragments is shown diagrammatically in FIG. 11. The process starts by inputting the ordered list of demand nodes resulting from the topological order step discussed above at step 300. At step 302, the system checks to see if all of the demand nodes have been treated. Assuming that there are untreated demand nodes, the system picks the first untreated demand node in the ordered list at step 304. In steps 306 and 308, the system attempts to select the best airplane from among the airplanes which are available to fly the flight specified by the origin, destination, and departure time of the demand. In these steps, the system seeks to find an airplane which, given the current state of the resource database, is indicated as available at the airport where the flight is to originate, or which can be flown to the origin airport and made available for the flight. From among these aircraft, the system seeks a particular aircraft which will have the least negative impact on CTM. Because it is almost always better to use an aircraft which is already parked at the origin airport, the system first examines airplanes which will be at the origin airport at the time of departure, in step 306. If a satisfactory airplane is found, the system skips step 308, and hence, does not examine the possibility of using airplanes which will be located elsewhere at the time of the operation.

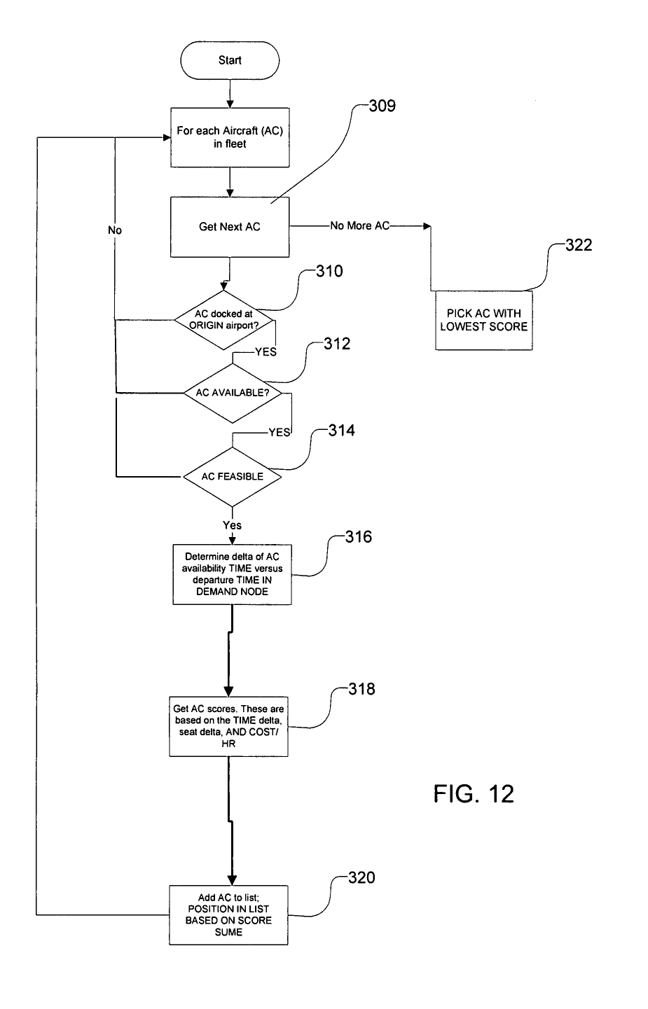

A selection process usable in step 306 is shown schematically in FIG. 12. At step 309, the process selects an aircraft from the fleet. If the resource database indicates that the aircraft will be docked at the origin airport indicated in the demand node, either at the departure time indicated in the demand node or within some predetermined window, such as an hour after the departure time, the system proceeds to the next step 312. Otherwise, the system discards the aircraft and returns to the aircraft selection step 309. At step 312, the system checks the resource database to determine whether the aircraft has been committed to another flight or to maintenance during the time required for the flight specified in the demand node. If the aircraft is not available, again, the system discards the aircraft and returns to step 309. If the aircraft is available, the system also checks whether the aircraft is a feasible aircraft for use in the flight specified in the demand node. For example, the system checks the range of the aircraft type against the length of the flight between the origin and destination airports. If the aircraft does not have sufficient range, it is not a feasible aircraft for the flight. Other factors can be considered in determining feasibility. For example, if the destination airport does not have sufficient runway length to accommodate an aircraft of a particular type, any aircraft of that type may be excluded. Assuming that an aircraft is not excluded, the system in step 316 determines the difference or “delta” between the time the aircraft will become available at the gate, according to the resource database, versus the departure time specified in the demand node. Of course, if the database indicates that the aircraft will be available at the requested departure time, delta would be 0.

In a further step 318, a system computes scoring factors for use of the selected aircraft in the demand node. One scoring factor is based on the availability time delta computed in step 316. This scoring factor may be based on an arbitrary value per minute set by the airline. Alternatively, this scoring factor may be computed based on a measure of variance in the demand nodes, such as the step function relating number of passengers to departure time discussed above with reference to FIG. 9. Thus, if the demand node includes a function relating number of passengers to departure time such as the step function of FIG. 9, the system may calculate the expected number of passengers based on that function so as to reflect the effect of changing the departure time to match the time when the aircraft will be available. The difference between the number of passengers in the demand node and the number of passengers resulting from evaluating the variance with time can be multiplied by the expected revenue per passenger to get a score or cost associated with delayed availability.

Additionally, the system computes a score or cost based on the cost per hour of flying the currently selected airplane. The system also computes a seat delta, i.e., the amount by which the number of passengers expected exceeds the number of seats in the aircraft. This cost is simply the product of the difference between number of seats and number of passengers multiplied by the expected revenue per passenger in the particular class. The system adds the various scores and computes a total score. This total score represents the negative effect on CTM of flying the particular aircraft, and thus represents D₁ of FIG. 10, and also represents the negative effect on CTM of any delay in the flight time caused by selection of the particular aircraft or any lack of capacity, and thus represents D₃ in FIG. 10. The system adds the aircraft to a list of feasible aircraft. The position of the aircraft in the list is based on the score. Therefore, the list is topologically ordered according to the scores of the various aircraft. The system returns to step 309 to process the next aircraft. If there are no more aircraft to be processed, the system branches to step 322 and picks the aircraft with the lowest score in the list and branches to the crew selection step 324, FIG. 11. If no aircraft are found in the list, this indicates that there are no feasible aircraft available at the origin airport specified in the demand node, and the system branches to step 308.

Step 308 is substantially identical to step 306, except that step 308 considers only aircraft which are not indicated as docked at the origin airport, and includes additional substeps to determine, based on information in the resource database, whether the aircraft can be flown to the origin airport in time to meet the departure time or within a specified window such as one hour after the departure time. Also, in step 308, the score for each aircraft includes a cost for the flight from the airport where the airplane is located at the relevant time to the origin airport. If no airplane is found in step 308, this indicates that the demand node cannot be met with the resources in the state indicated by the database. Thus, no schedule fragment is generated for the demand node. Instead, the demand node is simply marked in step 326 to indicate that this particular demand node was skipped as a result of having no feasible airplane.

When an airplane has been selected in step 306 or 308, the departure time of the flight operation servicing the demand node is adjusted to the time when the aircraft is available, if such time is different from the time specified in the demand node. Stated another way, the system adapts the schedule fragment to meet the available aircraft resources.

If an airplane is selected in step 306 or 308, the system passes to the crew selection step 324. The crew selection step is performed in a manner similar to the airplane selection steps 306 and 308. Thus, the system examines available crews, selects those which are feasible, and finds the lowest-cost feasible crew. The system desirably also considers balancing crew duty hours, so that crew members do not exceed maximum duty hours per month or per year. For example, an additional cost can be assigned to any crew member directly related to the number of duty hours previously scheduled for such crew member during the month being considered. The crew selection step uses the departure time and aircraft type found in the airplane selection steps. Thus, to be feasible, a crew must be qualified to fly aboard the type of airplane selected in step 306 or 308, and must be available at the origin airport at the departure time established in step 306 or 308. Also, the crew must have sufficient on-duty hours remaining at the departure time to allow the crew to complete the flight. The crew selection step may first address crews which, according to the resource database, will be disposed at the origin airport, and then address crews which can be relocated to the origin airport. Also, the crew selection step may process complete crews for the aircraft type, and then, if no complete crew can be found, the crew selection step may seek to find individual crew members to form a complete crew. Alternatively or additionally, the crew selection step may treat crew members having no duty history first, and then treat those crew members who have had duty history since their last previous day off duty. This can be helpful inasmuch as the computations required to determine whether a particular crew member has sufficient remaining duty hours given all of the constraints on duty hours may be time-consuming.

If no crew can be found, the system does not form a schedule fragment, but instead branches to step 328 and marks node as skipped because no crew was available. In a variant, if the failure to find crew was caused by the lack of a crew member having certain specific qualifications, as for example, the failure to find a pilot qualified on Boeing 747s, the system may mark the node with that specific indication.

Assuming that a crew is found, the system computes a score reflecting the cost of the crew, as for example, a score which reflects both the basic salary of the crew and any premium payments such as overtime, layover costs, and crew relocation flights which are associated with the crew. This score represents D₂ in FIG. 10. If a crew is found, the system branches to step 330 and searches for feasible gates at the origin and destination. Here again, if no gate is found, the system does not form a schedule fragment, but instead marks the node as skipped due to unavailability of a gate at a particular airport.

Assuming a gate is found, the system forms a schedule fragment and implements this schedule fragment by marking the resource database to commit the airplane, crew, and gates found in the preceding steps. Thus, the resources are indicated as occupied during the time required to complete the flight. Also, the system marks the database to indicate that the mobile resources, including the airplane and crew, will be positioned at the destination airport at the time corresponding to the end of the flight. The system also updates the status of the aircraft to indicate additional flight time since last maintenance, and updates the status of the crew members to indicate the additional duty time they will have devoted to the flight.

At this point, the individual schedule fragment is complete. The system may also record the expected contribution to margin of the flight if flown according to the schedule fragment at step 336.

In a variant, the system may test the proposed schedule fragment against one or more drop criteria before committing the sources at step 334. For example, if the proposed schedule fragment would result in a negative contribution to margin, the system may not commit the resources, but instead may mark the demand node as skipped due to negative CTM and return to step 302. In yet another variant, the system may override the drop criterion if one or more retention criteria are met. For example, the system may be arranged to retain the schedule fragment if the demand node is marked as a feeder for another demand. In a further variant, the retention criteria may include service to particular cities of particular importance to the airline. In yet another variant, the system may reexamine some previous allocations of resources. For example, if the results of the aircraft selection steps 306 and 308 indicate that no aircraft is available to meet the demand, or that the only aircraft available to meet the demand will yield poor results because they are much smaller than or much larger than the expected number of passengers, the system may examine aircraft previously assigned to flights which will arrive at the origin airport within a few hours after the departure time of the demand being treated and determine whether it is feasible to reschedule those flights so that the aircraft arrives earlier and, if so what the effect on CTM or other result would be. The system may also seek to reschedule a previously-scheduled flight if the first pass indicates that the selected aircraft will be available after the departure time in the demand being considered, and that such delay will reduce CTM from the demand being considered. In a further variant, the system can test the effect of splitting or combining demands at this stage. For example, if there is a first demand with a first departure time and 100 passengers expected, and the best available aircraft has 200 seats, the system may look for a demand with another departure time and determine whether it would be more profitable to combine the two demands. This stage can use a process similar to that discussed above with reference to FIGS. 7 and 8. However, in this case the examination of possible combining an splitting is performed based on those aircraft which would actually be available at the departure times of the combined or split demands in question, rather than on the best possible aircraft.

After a schedule fragment has been completed for a demand node or the demand node has been skipped, the system checks if there are more demand nodes to be treated at step 302. If so, the system picks the next demand node at step 304 and repeats the steps discussed above. If there are no further demand nodes, the schedule is complete. The system may output a total expected CTM resulting from adding all of the CTMs associated with the individual schedule fragments.

As indicated above with reference to FIG. 1, the system may adjust the resources and repeat either the entire scheduling process or a portion of the scheduling process. The adjustment to resources can be based on the information about the causes of skipped demands acquired when demands are marked at steps 324, 328, and 332. For example, if the markings indicate that numerous demands are being skipped to a shortage of flight attendants qualified on Embraer airplanes, and that these skips occur primarily on March 31 and later, the system may adjust the database of resources to indicate that there are additional flight attendants so qualified and issue an indication that such additional flight attendants should be hired and trained to be available as of March 31. The system may recalculate the entire schedule based on the assumption that a certain number of additional flight attendants are available for March 31 onward. Alternatively, if the demands have been ordered according to departure time and date, the system may recalculate only that portion of the schedule from March 31 onward, and concatenate the recalculated schedule with the earlier-calculated schedule prior to March 31 to form a composite schedule. Total CTM for the recalculated schedule can be compared to the CTM for the original schedule to determine whether the suggested change in resources is economically desirable. Likewise, if the skipped node indications suggest that additional airplanes of a particular type should be made available, the system may alter the database of resources to indicate that such additional airplanes are available, recalculate the schedule or a portion of the schedule with such indication, and compare the CTM of the recalculated schedule with the CTM of the original schedule to determine the advantage obtainable by acquiring or leasing more airplanes.

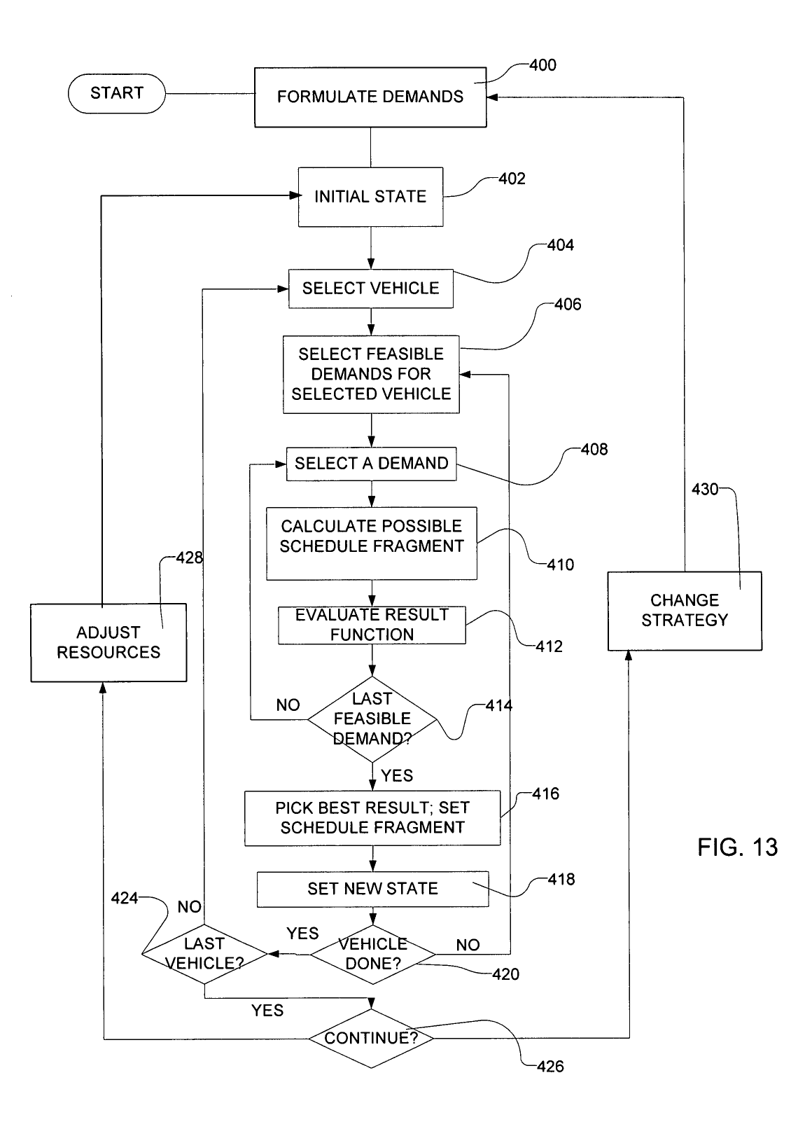

A process according to another embodiment of the scheduling system, schematically illustrated in FIG. 13, utilizes demands similar to those discussed above. The demands may be formulated in step 400 by essentially the same processes as discussed above with reference to FIGS. 2-9. Here again, each demand may include an origin, a destination, and a desired departure time or arrival time, and desirably also includes information specifying an estimated load such as a passenger load in each fare class in the case of a passenger airline. Here again, each demand may include information relating load (such as passenger load or passenger load in each fare class) to departure time or arrival time. Here again, the system maintains a database of resources which includes at least a list of vehicles, and desirably includes a list of vehicles having information as discussed above such as the status of each vehicle, as for example, disposed at a particular terminal such as an airport or en route, for each time during the future interval which is to be encompassed by the schedule. The database desirably also includes other resources, as for example, terminal gates and crews, and desirably includes the same information as discussed above. Here again, at the start of the scheduling procedure, the database is in an initial state.

The system selects a particular vehicle from the database at step 404. This selection may be based upon an ordering of vehicles by type or even by vehicle identity. For example, an airline may choose to schedule its most expensive airplanes first, so as to make the best use of these particular airplanes, in which case the most expensive airplanes would be first in the order of vehicles, and hence, one of these most expensive airplanes would be selected first.

Having selected a particular vehicle, the system at step 406 evaluates the state of the vehicle, finds the next time when the vehicle will be available, and selects a set of feasible demands which could conceivably be met by use of the selected vehicle. For example, if the selected vehicle is listed in the database as being occupied in maintenance or in previously scheduled operations through a particular date and time, the system may select a set of feasible demands by excluding those demands having departure times long before the particular date and time when the vehicle will become available. Also, the system at this stage may exclude demands which are infeasible for the particular vehicle, as for example, those demands calling for a destination airport having runway length smaller than that required by an aircraft in question, or having a flight distance longer than the range of an aircraft in question. The system may also exclude demands which may be technically feasible but highly unlikely to yield a profitable result if served with this particular vehicle, as for example, demands with origins located more than a certain distance from the location of the vehicle as indicated by the database. It is possible to omit this step and use as the set of demands all of the demands in the database; infeasible demands can be excluded during later stages. However, selecting a set of feasible demands reduces the number of calculations.

At step 408, the system selects one of the demands in the set from step 406, and then, at step 410, calculates a schedule fragment for the demand based on the assumption that the particular vehicle selected at step 404 will be used to fulfill that demand. The step of calculating a schedule fragment can be performed using steps similar to those discussed above so as to select the best resources, such as crew and gates, to complete the schedule fragment and to adjust the departure time, if necessary, to a departure time at or after the availability time of the aircraft. Here again, the system calculates a result function at step 412 for the possible schedule fragment resulting from step 410. As discussed above, the result function may include a financial result such as CTM for the possible schedule fragment. The result function optionally may include a penalty for idle time spent by the aircraft from its availability time to the departure time. At step 414, the system determines whether all of the demands in the set of demands from step 406 have been processed. If not, the system returns to step 408, selects another demand from the set, and repeats steps 410 and 412 for that demand, so as to provide a possible schedule fragment and the associated result function for the next demand. This process continues until all of the feasible demands have been processed to yield possible schedule fragments and associated result functions. The system then branches to step 416, where it selects the particular demand which has yielded the best result function, as for example, the highest CTM of all the demands in the set from step 406. In this regard, if step 406 was omitted or used very broad criteria so that the set included infeasible demands, the system would determine feasibility during the step of calculating a possible schedule fragment (step 410), and would exclude any demand which resulted in infeasibility from the selection at step 416.

Once the best result has been selected, a schedule fragment is set by taking the conditions specified in the possible schedule fragment associated with the best result and committing resources, including the selected vehicle and other resources, to that schedule fragment. Thus, the database is updated at step 418 to a new state, indicating that the selected vehicle and any other resources used in the set schedule fragment are committed. Once the new state has been set, the system returns again to step 406 and selects a new set of feasible demands for the selected aircraft based upon the new state. For example, if the last previous pass through steps 406-416 resulted in setting a schedule fragment which takes the vehicle to San Francisco as its destination, and which makes the vehicle available for further use at 3:00 p.m. on a particular date, the next pass through steps 406-416 will result in selection of the demand which best utilizes the aircraft based on its position in San Francisco and its availability time of 3:00 p.m. on that date. This process continues until, at step 420, the system determines that the vehicle is completely scheduled through the interval of time to be covered by the schedule being generated. If the vehicle has been completely scheduled, the system checks at step 424 to determine if this is the last vehicle to be scheduled. If not, the system branches back to step 404, selects the next vehicle and repeats steps 406-420 with that vehicle, so as to develop a full schedule for the next vehicle in the same manner; and the process repeats until all vehicles have been scheduled, whereupon the schedule is complete.

Scheduling in this manner uses the same general approach as discussed above with reference to FIG. 10, i.e., picking conditions which minimize the cost or maximize some other result for a particular flight operation. In this embodiment, however, the demands are addressed in the order in which they become feasible for a particular aircraft. Stated another way, this embodiment follows an aircraft through the schedule and finds the best use for that aircraft at any time during the schedule, repeating the process until the aircraft has been fully scheduled for the required time intervals. In a variant of this process, the system may not compute the entire schedule for each vehicle before selecting the next vehicle. For example, after setting a new state recording a schedule fragment for a particular vehicle, the system may branch back to step 404 and select another vehicle. The step of selecting a vehicle may be configured in this embodiment to select a vehicle from among all of the vehicles of a particular type based on the number of times that vehicle has been selected, so that the vehicle which has previously been selected the fewest number of times will be picked. In this manner, the system essentially finds the best use for each vehicle in a first operation starting from the initial state. Then, when the state of the system indicates that each vehicle has been scheduled for a first operation, the system seeks the best use of each vehicle once again for a second operation. This process continues until all of the vehicles have been scheduled throughout the entire time interval time to be covered by the schedule.

In each of these embodiments, after a complete schedule has been formulated, either a human operator or the system may decide to adjust resources as indicated schematically at step 428, or to change the strategy by which demands are formulated as indicated schematically at step 430 and repeat the process to generate another schedule. Here again, schedules developed with various sets of resources, and different strategies can be generated rapidly and can be compared with one another.

In yet another variant, the system may use the vehicle-ordered scheduling approach discussed above with reference to FIG. 13 to set a portion of the schedule, and may use the demand-ordered approach discussed with reference to FIG. 11 to set the other portion of the schedule. In the embodiments discussed above, the scheduling process includes resources other than vehicles, i.e., crew and airport gates. In a more limited variant, the scheduling processes discussed herein can be used to schedule only vehicles, and external processes can be used to schedule other resources. In this more limited variant, the database may include only information pertaining to vehicles.

The systems discussed above desirably provide times for maintenance of vehicles. For example, aircraft typically must be serviced at the end of each flight. Maintenance of this type typically requires a fixed interval and can be performed at any location. Therefore, the system desirably simply adds an interval for maintenance at the end of each flight. Other maintenance, commonly referred to as “C” and “D” maintenance, must be performed at specified maintenance centers, which may or may not be at terminals served by the airline. Maintenance of this type must be performed at intervals set by rules which may include, for example, specified numbers of flying hours, takeoffs or landings, or calendar days, or some combination of these. As set forth above, the resource database maintained by the system contains status information for each aircraft, which includes these factors. The system may review the database or a portion of the database pertaining to a particular aircraft each time the aircraft is incorporated into a schedule fragment. If the status of the aircraft at the end of the new schedule fragment will be such that the aircraft requires maintenance, the system may simply schedule the aircraft a priori for the particular maintenance required, mark the resource database to indicate that the aircraft will be out of service for the required interval (typically days or weeks), and pass a signal to a maintenance control system or to a human operator indicating when the aircraft will be made available for maintenance and the type of maintenance required. In a further variant, if the status information for a particular aircraft indicates that a maintenance deadline is approaching, the system may set an artificially low cost for the aircraft to fly to a destination at or near the appropriate maintenance base, thus increasing the probability that the next scheduled demand will take the aircraft to or near the maintenance base. The ability to interact with maintenance systems and to schedule aircraft realistically with full cognizance of required maintenance provides a significant advantage.

Each of the systems discussed above begins the scheduling process based upon an initial state of the aircraft and other resources, and builds the database of future states which the aircraft are expected to be in at future times by generating the schedule fragments. Most typically, the initial state is a predicted state at some time after the scheduling operation is performed. For example, an airline may use the system during January to generate a schedule for operations during July and August, such schedule being based upon an assumed initial state of aircraft as of July 1. However, because the scheduling process is extremely rapid, it can be used as a real-time scheduling tool, with the initial state being an observed state on the date of scheduling. Thus, the scheduling process can allow the airline to react to actual events such as weather disruptions by picking the most efficient schedule to fly from that date forward.

In the discussion above, the result function has been stated in terms of a financial result, such as CTM. However, non-financial results also can be evaluated. For example, the result function for a particular demand may include waiting time for passengers transferring from feeder flights. Waiting time can be evaluated independently or can be translated into a financial cost reflecting the airline's expectation that a passenger inconvenienced by a lengthy layover time will become a less loyal customer. Such a cost may be subtracted from CTM to yield a final result function.

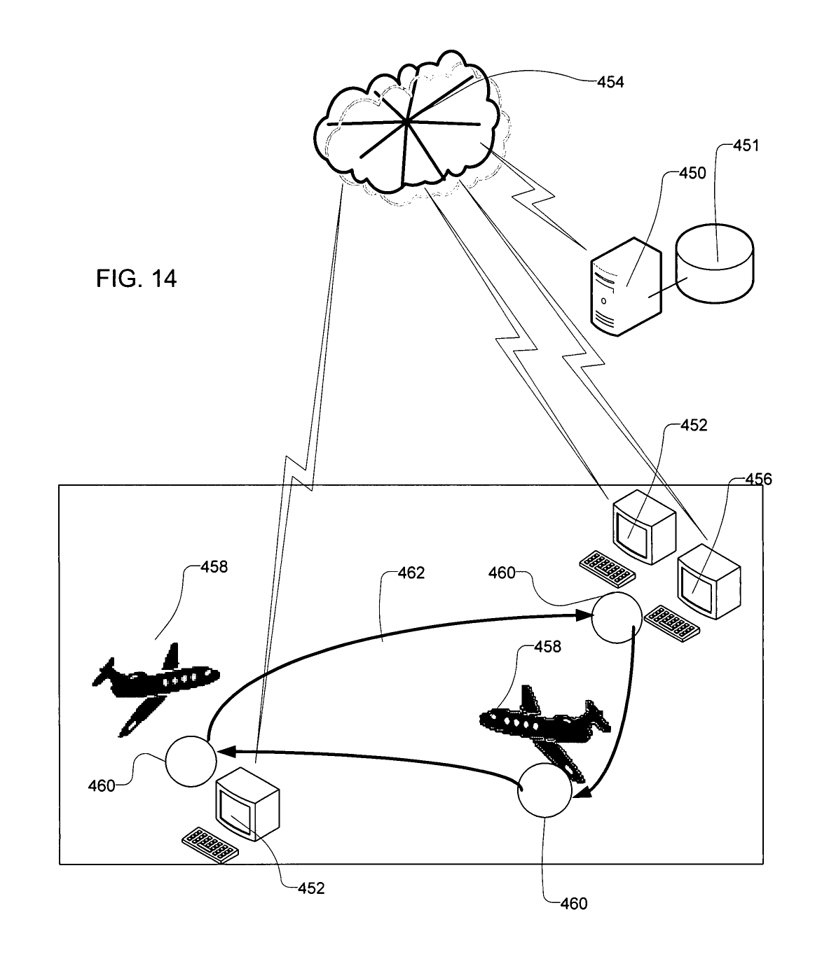

The computations discussed above can be performed using a conventional general-purpose computer 450 (FIG. 14) which includes the normal elements of a computer, such as a processor, and a memory for holding the resource database and schedule fragments. The computer also includes a programming element which includes a computer-readable medium 451 and a program stored on such medium, the program being operative to cause the computer to perform the steps discussed above. The medium 451 may be separate from the memory used to store the resource database and schedule fragments, or may be integrated therewith. For example, the medium 451 may be a disk, tape or solid-state memory incorporated in the computer. As shown symbolically in FIG. 14, one system for performing these calculations includes a computer 450 programmed to perform the operations discussed above; and also includes one or more input nodes 452 for supplying input information which at least partially defines services to be provided in the transportation operation to be scheduled. In the embodiment depicted, the input nodes 452 are shown as input terminals, and these nodes can be used to supply any of the elements of information to be processed in the methods as discussed above. The system further includes at least one output node 456 arranged to receive information representing at least some of the resources assigned to schedule fragments from the computer 450. Desirably, each output node 456 is arranged to display or output this information in human-readable form, as for example, on a screen display or printout. Although input nodes 452 and output nodes 456 are shown separately, these nodes may be combined with one another. The input and output nodes may be connected to computer 450 directly if the nodes are in the same location as the computer. Nodes 452 and 456 may be disposed at locations distant from computer 450, and may be connected to the computer by any suitable means of communication, as for example, by a local connection through a network such as the internet 454, schematically depicted in FIG. 14. Although computer 450 is shown as a single element in FIG. 14, the elements of computer 450 may be distributed at various locations connected to one another by any suitable means of communication. Also, although the input and output nodes desirably are linked to computer 450 by a network or other form of instantaneous communication, this is not essential; the input and output nodes may be arranged to provide the input information and receive the output information in hard copy or on suitable electronic media that can be physically transported between the nodes and the computer.

The computer input nodes and output nodes form part of a larger transportation system which includes vehicles such as aircraft 458, and terminals 460 such as airports. As discussed above, the schedule defines routes between terminals 460, which correspond to physical routes 462. The input and output nodes may be located at one or more of terminals 460, or at another location.

Strategic Planning and Revenue Management

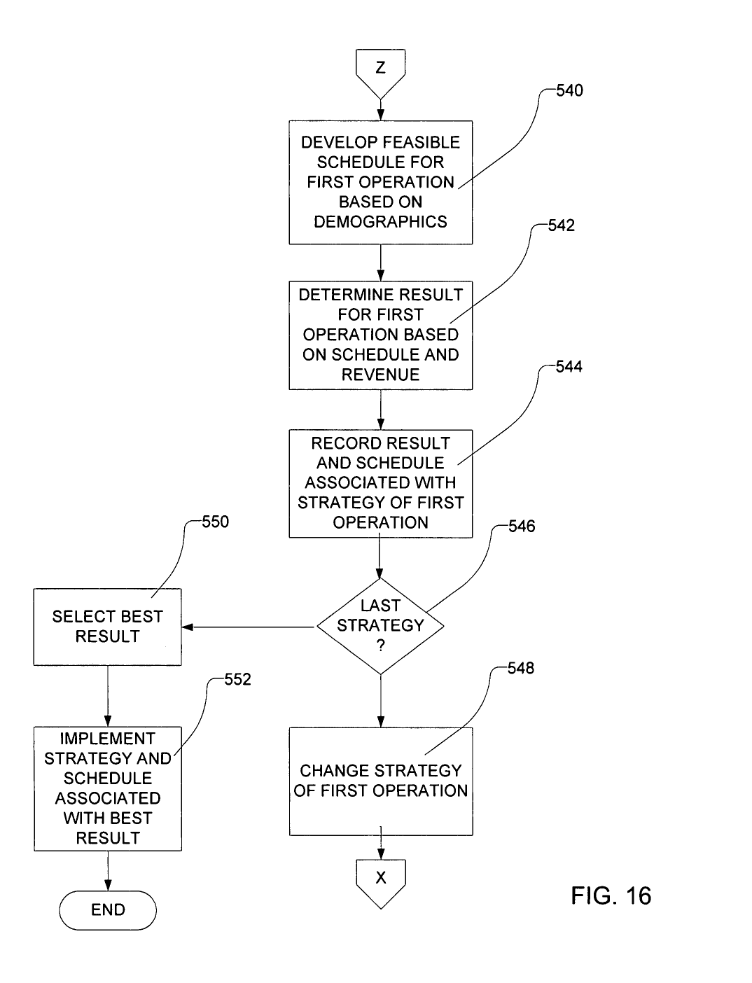

A method of planning in accordance with one embodiment of the invention (FIGS. 15 and 16) is intended to determine a desirable strategy for a particular transportation operation such as an airline. The term “first transportation organization” is used herein as referring to the organization which is using the method to select its own strategy. By contrast, the term “competitive organization” is used herein as referring to any other transportation organization which competes with the first transportation organization in the marketplace. Also, the term “internal strategy” is used herein as referring to a possible strategy being considered by the first transportation organization or which is adopted by the first transportation organization. The term “external strategy” is used herein as referring to an actual or possible strategy of a competitive organization.

As shown in FIG. 15, the method begins at step 502 by supplying to the computer system data defining origins and destinations which are under consideration for service by the first transportation organization, as well as market information defining the expected number of passengers who are expected to travel between each city pair (origin and destination) by date. The market information desirably includes data for each city pair defining the total number of passengers who will be expected to travel from the origin to the destination on each day in a time period in the future referred to herein as the “planning period.” The planning period is the period in the future when actual travel will occur. For example, the strategy selection process may involve a year beginning at some time in the future. The market data desirably is abstracted into numbers of passengers traveling within intervals during the day, such as the “windows” discussed above with reference to FIGS. 3 and 4. The market data may be abstracted from historical passenger data for travel between the origin and destination cities in the same manner as discussed above with reference to FIGS. 3 and 4.

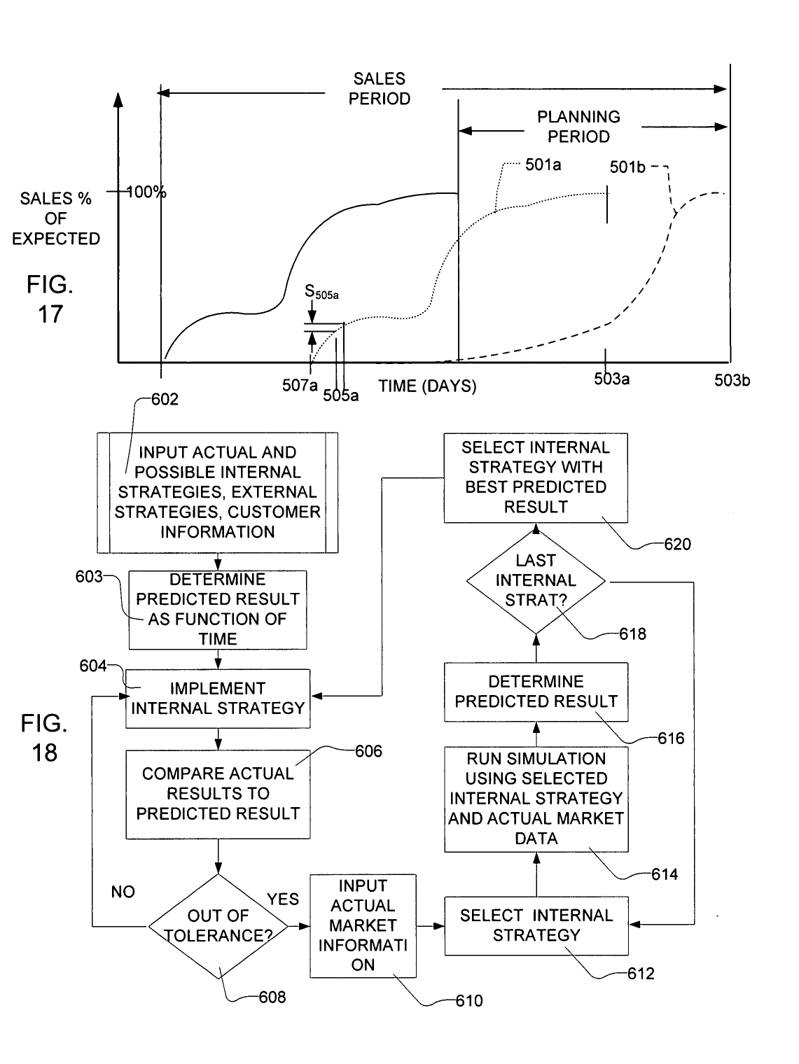

The market data further includes a subset of information referred to herein as customer information defining a statistical model of the behavior of the individual customers expected to purchase transportation between the cities of the city pairs. One aspect of customer information includes information defining a booking curve, i.e., the proportion of passengers who have purchased tickets as a function of time until flight time remaining to departure time. A few booking curves 501 are illustrated diagrammatically in FIG. 17. Curve 501a represents the proportion of those travelers expected to travel in a particular window on date 503a within the planning period, who have purchased tickets as of particular dates before date 503a. The curve indicates that on day 505a, a particular fraction f505a of the total expected passengers will purchase tickets. Curve 501a indicates that a substantial proportion of passengers purchase tickets far in advance of the flight date. Curve 501b is a booking curve for a window near the end of the planning period, associated with a different city pair. Note that in curve 501b, only a small proportion of passengers purchase tickets more than a few weeks before the flight date. For example, curve 501a may represent the behavior of passengers traveling to a vacation destination, whereas curve 501b may represent passenger behavior for flights between business destinations. The number of different booking curves used with different windows will depend on the quality of the customer information; it may be as coarse as a single generic booking curve for all windows or as fine as an individualized booking curve for every window. As also shown in FIG. 17, it is assumed that sales of tickets will begin prior to the planning period, and that sales for travel within each window will continue up until the flight date associated with that window. Thus, it is assumed that sales will occur during a sale period commencing before the planning period and ending on the last day of the planning period. The term “ticket” is used in this disclosure as referring to the right to transportation, which may be evidenced by a paper document or by an entry in a computer system commonly referred to as an “e-ticket.”

Another aspect of customer information includes data defining sensitivity of the customer to price of transportation and sensitivity of the customer to other elements of value associated with transportation. For example, the behavior of an individual customer in deciding which ticket to purchase from among those offered by competing organizations may be modeled by assuming that the customer will purchase that ticket which gives him or her the highest value of a desirability function D_{R} as follows:
D_{R}=−(P)aₚ+(X₁)a₁+(X₂)a₂ . . . (Xₙ)aₙ (1)
where:

P is the price charged for the ticket;

aₚ is a coefficient defining the customer's price sensitivity;

X₁ is a number defining the degree to which the transportation purchased affords a particular amenity;

a₁ is a coefficient defining the customer's sensitivity to the amenity represented by X₁;

X₂ and a₂ through Xₙ and aₙ have meanings similar to X₁ and a₁, but refer to a different amenity. The ellipsis indicates that any number of amenities or other elements of value associated with transportation may be represented in similar fashion. Each number X₁ through Xₙ may be a binary (0 or 1) indicating the presence or absence of a particular element of value (e.g., in-flight movie offered or not offered) or may be a real number (e.g., leg room in centimeters), and the coefficients may be selected accordingly.

In this embodiment, the customer data is modeled as a few discrete classes of customers. For example, one class of customers referred to as a “price-sensitive” class has a very large coefficient aₚ associated with price, and very small, or even zero waiting factors a₁-aₙ associated with the other amenities being modeled. Another class of customer referred to herein as a “service” customer has a relatively small price coefficient aₚ and larger coefficients for other elements of value. Another class of customer referred to herein as a “value” customer has coefficients intermediate between those of the price-sensitive customer and those of the service-oriented customer.

The customer data for the market as a whole, or for a given portion of the market, may be represented by percentages of price-oriented, service-oriented, and value customers. Typically, the customer data is segmented for different portions of the market. For example, a set of city pairs incorporating a vacation destination may have a high proportion of price-sensitive customers, whereas a set of city pairs having business-oriented destinations may have a large number of value-oriented customers and service-oriented customers. The customer data may be further segmented by date. For example, windows on days corresponding to the beginning of the academic year and school vacations may be assigned higher proportions of price-sensitive customers.

The method further includes (step 504) inputting one or more internal strategies of the first transportation organization. Each internal strategy typically includes a set of city pairs to be served by the first organization, initial prices and sets of amenities to be offered by the first transportation organization for transportation between each city pair on each date during the planning period, as well as rules for modifying prices, amenities, or both in reaction to events. For example, the internal strategy may provide for initial prices of tickets for a particular city pair in various classes of service and a rule specifying that if less than a predicted number of tickets in the lowest-priced class of service has been sold by X days before the flight date, the first organization will reduce the prices charged for the lowest class of service by Y %. In another example, the rule may specify that if less than a certain number of tickets have been sold in a high class of service, the first organization will begin offering an amenity (e.g., an additional baggage allowance) in that class of service. Another possible rule would be to match the lowest price offered by a competitive organization. Essentially any aspect of price or value to the customer, and any reason for modifying the same, can be incorporated in the rules constituting a strategy. Also, an internal strategy for the first organization can be, and desirably is, segmented into multiple constituent strategies which differ from one another, and which apply to different portions of the market as, for example, different city pairs. Merely by way of example, an airline may choose to adopt an aggressive, price-cutting strategy for certain city pairs and an amenity maximization strategy for other city pairs. As further explained below, a strategy may incorporate different constituent strategies which are applied selectively to different customers, depending on the characteristics of the customer.

The input step 504 also loads into the system data defining the external strategies used by competitive organizations. The external strategies are defined in substantially the same way as the internal strategy, but represent the best understanding of the strategies which competitors are expected to use. The external strategies may include capacity limitations. For example, the strategy of a competitor may be modeled as including a term which forces the competitor to simply stop selling tickets when it reaches a certain number of tickets in a particular window or on a particular day. As explained below, the capacity limitations of the first transportation operation are reflected in other steps of the method, and it is therefore not normally necessary to include capacity limitations in an internal strategy. However, capacity limitations can be included in internal strategies as well. In this regard, numerous air transportation organizations use strategies according to the Sabre system.

In the next stage of the operation (step 506), the system initializes the date to the first date within the sale period, i.e., the date on which the first tickets will be sold by the first organization for flight in any window within the planning period. This date typically is about 360 days before the first flight date in the planning period. The system also and sets the terms for transportation offered by each organization according to the initial terms specified by the strategies loaded at step 504. The system then conducts a simulation of the behaviors of customers who shop for and purchase tickets during the planning period, and the reactions of the various organizations during the planning period. The simulation is performed as a multi-player game. In step 508, the system selects a window during the planning period, representing the market for travel during a particular range of times on a flight date during the planning period. In this selection, the system may exclude any windows for flight dates late in the planning period, more than the specified number of days for ticket sales, typically 360 days. The system then calculates number of passengers who can be expected to purchase tickets for travel within the selected window on the first day of the sale period in step 510. This can be calculated from the total number of expected passengers expected to travel in the window and the booking curve data associated with the window. On a given sale date (SD), the number of tickets sold for a given window representing travel between a given city pair (CP) on a given flight date (FD) and time (T) is given by:
S_{SD,CP,FD,T}=(N_{CP,FD,T})(f_{(FD-SD)}) (2)
where:

S_{SD,CP,FD,T} is the number of customers who will purchase tickets on sale date SD for the window (i.e., for the particular city pair CP, flight date FD, and range of times T);

N_{CP,FD,T} is the total number of passengers expected to purchase tickets for flights within the window (i.e., between city pair CP on flight date FD and range of times T);

(FD−SD) is the number of days between the flight date and the sale date; and

f_{(FD-SD)} is the fraction of passengers expected to purchase tickets (FD−SD) days in advance of a flight within the window, as defined by the booking curve data.

If the number of passengers expected to purchase transportation within a particular window on the sale date is 0, the system returns to step 508 and selects another window during the planning period. Assuming that there is at least 1 customer expected to purchase transportation within the window on the sale date, the system then creates a first hypothetical passenger and sets the characteristics of the passenger. As mentioned above, it is assumed in this embodiment that the passengers fall into three discrete classes (price-sensitive, value-sensitive, and service-sensitive), and the proportions of each are known for each window from the customer information input at step 502. In step 512, the system conducts a customer type assignment process based on these proportions. For example, the system may generate a random number and assume that a passenger is a price-sensitive passenger if the random number falls within a range of random numbers associated with price-sensitive passenger, assume that the hypothetical passenger is a value-sensitive passenger if the random number falls within another range, and assume that the hypothetical passenger is a service-sensitive if the random falls within yet another range associated with service-sensitive customers. The size of the range associated with each class of customers is proportional to the proportion of price-sensitive customers expected. Once the customer type has been assigned, the system sets the coefficients used in the desirability function discussed above according to the values associated with the selected customer type. For example, if the hypothetical passenger is price-sensitive, aₚ will be relatively large, and a₁-aₙ will be relatively small or zero.

In the next step 514, the system applies the characteristics of the customer to the terms for transportation being offered by each transportation organization which provides service within the window. Thus, the system evaluates the desirability function D_{R} using the price and amenities offered by the first transportation organization and by each competitive organization.

In step 516, the system selects the particular organization associated with the greatest value of the customer's desirability function D_{R} and assigns the sale to this particular hypothetical customer to that organization. The system maintains a tally of tickets sold within each window by each organization in each class of service, and a similar tally of revenue generated by each organization within each window and class of service. When a sale of a ticket for transportation within a particular window and class of service is assigned to a particular organization, the tally of tickets sold in that window and class is incremented by 1, and the tally revenue is incremented by an amount equal to the price which is being charged by that organization for such transportation on the sale date in question.

In the next stage 518, the system checks to see if there are any further hypothetical customers expected to purchase tickets for the particular window in question on the sale date and, if so, loops back to step 512 to process the next hypothetical customer as discussed above. Assuming that there are no more hypothetical passengers for that window and sale date, the system branches to step 520 and determines whether or not there are any more windows in the planning period to be subjected to hypothetical sales on the particular sale date in question. If so, the system branches to step 508 and selects a new window for processing in the manner discussed above. Once all of the hypothetical customers purchasing on the sale date for all windows within the planning period have been processed, the system has simulated an entire day's worth of purchases.

At this point, the system branches to step 524. In this step, the system examines the tallies of tickets sold and revenue accumulated for the various windows by the various organizations, as well as the prices being charged by the various organizations, and determines whether or not any of these factors will cause one or more of the organizations to change the terms which it is offering based upon the strategy being implemented by that organization. For example, assume that a competitive organization is following a strategy which causes it to cut prices for a particular class of service in all windows on a particular flight date if fewer than a particular number of tickets have been sold by 10 days prior to the flight date, and assuming that the sale date being processed is the day 10 days prior to the flight date. If the tally of tickets sold for all of the various windows on the particular flight date is less than the number contemplated by the strategy, the system reduces the prices being offered by the competitive organization. Assuming further that the first transportation organization is following an aggressive price-cutting strategy which causes it to match the lowest competitive price, the system will reduce the prices being charged by the first transportation organization for all windows served by both the first transportation organization and the competitive organization, as delineated in the strategy. Similarly, the system will adjust other elements of value according to the strategy set forth for each organization.

In the next step 526, the system increments the sale date by one day. At step 528, the system checks each window within the planning period and determines whether the new sale date is later than the flight date associated with the window, in which case the window is expired. Each expired window has been subjected to sales throughout the portion of the planning period which terminates on the flight date. Thus, the tally of passengers and revenue represents the expected number of passengers and expected revenue, which the first organization will realize if it implements the strategy which was input at step 504 and if the competitive organizations implement the external strategies also input at step 504. This information constitutes a city pair demographic usable in the scheduling method discussed above.

In the next step 530, the system checks to determine whether the sale date which was incremented in step 526 is beyond the last date of the sale period, i.e., typically beyond the last date of the planning period. If it is not, the system returns to step 508 and selects a window within the planning period for processing as discussed above, looping through steps 518 and 520 until all windows within the planning period have been processed to simulate sales occurring within the incremented sale date, under the terms of being offered by the various organizations on that date. Here again, once all windows have been processed to simulate the results of sales on the incremented sale date, the system again examines the conditions prevailing in the market, including the numbers of tickets sold by each organization within each window, the prices charged by the various organizations, and so on, and again resets the terms (step 524), whereupon the sale date is incremented again (step 526) and expired windows, if any, are culled out (step 528), and the cycle repeats. As the sale date moves to progressively later dates, more of the windows expire; as each window expires, indicating that the sales of tickets have been simulated for all days up to and including the flight date, city pair demographics and revenues for the first operation are output for more windows. Finally, when the system reaches the condition where the incremented sale date is beyond the last date of the planning period, the cycle stops and the system branches to the further operations shown in FIG. 16, starting at connector Z.

In the next step 540, the system processes the city pair demographics to develop a feasible schedule for the first transportation operation to meet those demographics. This processing most preferably uses the scheduling methodology discussed above. As noted above, development of a feasible schedule takes account of the resources source such as vehicles as, for example, airplanes in the case of an airline, crews, and other facilities such as airport gates, and desirably uses adaptation as discussed above to select resources such as aircraft, crews, and gates used to meet a particular demand. For example, as mentioned above, the adaptation features of the scheduling system allow selection of resources even when those resources do not meet exactly the nominal conditions of a demand for transportation as, for example, where the system selects an aircraft which will be available slightly later than the desired departure time. As discussed above, the ability to use adaptation provides significant efficiencies. Further, the scheduling system can compute a feasible, flyable schedule in a few minutes or less. Most preferably, the step of developing a feasible schedule is performed by the same computer system as used to develop the demographics, and is performed as part of the same automated computation process.

As also discussed above, the scheduling system provides more accurate data as to revenues and costs. Thus, the steps discussed above with reference to FIG. 15 yield city pair demographics for the first transportation organization but normally are not constrained by the resources available to meet those demographics. The scheduling system which converts the city pair demographics into demands as discussed above and selects aircraft and crews to meet the demands develops an accurate indication as to how many passengers the first organization will be able to accommodate, given the available resources, how many will be lost due to scheduling at times other than the time associated with a demand, and so on. The scheduling system also accumulates data with respect to the costs which will be incurred by the operation as, for example, the operating costs of the airplanes involved and the crew pay required. Stated another way, the steps discussed above with reference to FIG. 15 develop a realistic figure of potential sales of tickets given a particular internal strategy, unconstrained by resources; whereas the scheduling steps (step 540 and 542) convert those potential revenues into more accurate estimations of the actual revenue which can be realized using available capacity and the costs associated with generating such revenue. In the manner discussed above with reference to the scheduling system, the scheduling system accumulates data from which a financial result can be determined as, for example, expected contribution to margin (CTM) from all of the operations specified in the schedule. The system then records the result, such as aggregate CTM, and the internal strategy of the first operation used in steps 506-530 (FIG. 15) to develop the demographics. At step 536, the system checks to see if the internal strategy used in the preceding steps was the last possible internal strategy loaded into the system. If not, and more internal strategies remain, the system branches to step 548 and selects a new internal strategy, whereupon the system returns (off-page connector X) to step 506 (FIG. 15) and conducts as new simulation to derive new city-pair demographics using the new internal strategy in the same manner as discussed above. Here again, after simulating the sales and the actions of the new internal strategy and competitive external strategies over the entire sale period, the system develops a new set of demographics and returns (off-page connector Z) to step 540, whereupon the system develops a new feasible schedule for the first operation using the newly derived demographics, based on the new internal strategy. Once again, the schedule and result are recorded. This process continues until all possible internal strategies originally loaded into the system have been tried and used to develop demographics, and until feasible schedules and results have been recorded for the demographics derived from each strategy. Each set of results and schedule is associated with the strategies to develop the demographics.

Once all of the potential internal strategies for the first operation have been tried, the system branches to step 550, where it selects the best result, most typically the result which yields the highest CTM. By selecting the best result, the first transportation operation has selected the associated internal strategy, and has also selected a schedule. The combined methodology of using a multi-player game to simulate actual marketplace behavior and thus develop accurate city-pair demographics, when combined with development of a feasible schedule, provides a realistic, accurate appraisal of the results which will be achieved from implementing a particular strategy. The ability to do so in a set of integrated computer operations allows a transportation operation such as an airline to actually use the system in its operations, and actually develop an integrated strategy and schedule which will be profitable. Having done so, the airline may implement the internal strategy in sales of tickets during the sale period and implement the schedule in operations during the planning period, as represented by step 552.

The strategic planning or strategy-selection methods discussed herein provide a significant advantage in that they normally do not lead a transportation operation into mutually-destructive strategies, such as a “price war” in which all competitors are selling tickets below cost. Normally, the strategy-selection methods discussed herein will tend toward a Nash equilibrium with the strategies used by competitive organizations, in which the first organization would not improve its results by changing the internal strategy and the competitive organizations would not improve their results by changing their external strategies.

The method as discussed above with respect to FIGS. 15-17 can be varied in many ways. For example, it is not essential to step through the simulation day-by-day; the various days of the sale period can be consolidated into larger blocks, such as weeks or even months, so that the sale date is incremented by weeks or months on each pass through step 526. Conversely, the step of resetting the terms offered by the various organizations (step 524) can be performed after each hypothetical sale (step 516) in the simulation so as to provide an even more accurate model of the manner in which the various strategies interact with one another, at the expense of greater computational overhead. Also, although the scheduling method discussed above is highly preferred, any other method capable of developing a feasible schedule from the city pair demographics can be used in step 540.

In a further variant, the various internal strategies for the first organization may be manually-input modifications of an existing strategy, and the process may start a new pass through the simulation (from step 506) in response to manual input of such modifications.

As pointed out above, the internal strategy of the first organization and the external strategy of each competitive organization typically include the city pairs to be served by the organization. By varying the city pairs served in different strategies tested using the method, a transportation organization such as an airline can accurately determine where it should deploy its resources. Also, as discussed above with reference to FIG. 1, the scheduling system can include provisions for varying the available resources and providing different schedules with different results (e.g., different aggregate CTM) using different resources and associated costs. Thus, the steps of determining a feasible schedule and the associated result (steps 540 and 542, FIG. 16) for each internal strategy may include determination of several feasible schedules using different sets of resources to meet the demographics derived from the internal strategy, and selection of the particular schedule and resource set which yields the best result (such as highest contribution to margin) as the schedule associated with the particular internal strategy. Also, the strategy selected may affect cost, capacity or both. For example, one of the elements of value forming part of a strategy may be passenger legroom, which translates directly into seat pitch and hence to passenger capacity. The system changes the passenger-carrying capacity of each aircraft depending upon the legroom incorporated in the strategy before the schedule-finding step. Also, if an element of value is a level of meal service, the scheduling system applies the associated cost in determining CTM. Costs associated with other elements of value can be accounted for in other ways. For example, an airline use a strategy which includes providing a high level of telephone reservation service, and the incremental cost of that service can be taken as a system-wide cost deducted from the aggregate CTM for the feasible schedule.

In another variant, the customer can be modeled using a multivariate model, with each of the coefficients aₚ, associated with price and the coefficients a₁ . . . aₙ associated with other elements of value in the desirability function D_{R} modeled as an independent distribution. The system may generate a random number for each element of value and set the coefficient based on the random number for the associated element of value. For example, each coefficient may be modeled as a set of discrete values of the coefficient, each such value being associated with a range of numbers. The size of each range is directly related to the probability that the associated discrete value will occur. The random number generated for the associated element of value falls in one of the ranges, and the corresponding coefficient is selected. In a further variant, some of the coefficients may be partially correlated with one another. For example, a particular coefficient aₘ may be modeled the sum of a value selected based on a distribution associated with aₘ and some multiple of another coefficient a₍ₘ₋₁₎. Such a correlation may reflect real-world experience as, for example, the fact that a passenger who values fast check-in service is quite likely to value fast telephone reservation service.

In yet another variant, the system can model elements of value which are limited by physical capacity aboard the aircraft as, for example, a guaranteed aisle seat or exit row seat. In this variant, the desirability function for each customer includes a coefficient reflecting value to the customer of the presence or absence of this element. A strategy may include a separate, typically higher, price for guaranteed aisle seating. The system keeps a separate tally of the number of tickets sold to hypothetical customers incorporating each such capacity-limited element of value, and thus develops separate city-pair demographics for passengers with and without such element of value. In effect, the system treats each capacity-limited element of value as a separate class of service. The scheduling system will process these demographics to develop demands reflecting these separate classes, each with a number of passengers and average revenue per passenger. The scheduling system will inherently impose capacity limitations which reflect the realistic capacities of the aircraft. To do this, the capacity data for each aircraft or aircraft type should include capacities for each capacity-limited element of value, e.g., so many generic coach seats, so many coach aisle seat, so many first class seats. As discussed above, when the scheduling system selects an aircraft to meet a particular demand during development of a feasible schedule (step 540, FIG. 16), the computation of financial results (step 542) will reflect the financial yield which is actually realizable from each capacity-limited element of value. The ability to determine this provides a significant benefit in selecting the most effective internal strategy. For example, a first strategy may price guaranteed aisle seats only $20 more than generic coach seats, whereas a second strategy may price the guaranteed aisle seats $100 higher than generic coach seats. Since many passengers place a high value on guaranteed aisle seats, the first strategy will result in vast numbers of sales of guaranteed aisle seats. Considered without reference to capacity, the first strategy would seem to yield higher revenue than the second. However, when capacity limits are applied, the second strategy will yield better results than the first.

Other elements of value can be effectively modeled without reference to capacity limitations. For example, there is no need for the scheduling system to take account of the number of passengers who elect guaranteed fast check-in.

As mentioned above, a strategy typically includes multiple constituent strategies associated with different segments of the market such as different city pairs or different dates. A internal or external strategy may also include multiple constituent strategies which are applied selectively to different customers purchasing tickets on the same flight, so that different terms for transportation are offered to different customers depending on the characteristics of the customer. For example, if the characteristics of the customer indicate that the customer is particularly sensitive to a particular element of value, the strategy may implement one constituent strategy, whereas if the characteristics of the customer indicate that the customer is sensitive to other elements of value, the strategy may implement another constituent strategy. In one such implementation the step of applying the terms offered by the various organizations to the characteristics of the customer includes a preliminary substep of evaluating the customer characteristics and deciding which constituent strategy to implement. This preliminary step is performed separately for each organization using selectively-applied constituent strategies. For example, an internal strategy may include a first constituent strategy of offering aisle seats and a relatively high price determined according to one set of rules to those customers having a large sensitivity coefficient an associated with aisle seating and a second constituent strategy of offering a relatively low price, determined according to another set of rules, to those customers having a large price sensitivity coefficient aₚ. In step 514, the preliminary step may evaluate the customer characteristics by examining the coefficients of the hypothetical customer's desirability function D_{R}, selects the first or second constituent strategy based on these results, and sets terms for transportation based on the selected constituent strategy. In effect, the system simulates the behavior of the organization reacting to customer requests, i.e., quoting one set of terms to a customer who insists on aisle seating and another set of terms to a customer who asks for the lowest-priced ticket.

In another implementation of multiple constituent strategies segmented by customer desires, the system may evaluate the customer's desirability function D_{R} for all of the different sets of terms which would be offered by a particular organization based upon all of the different constituent strategies used by that organization for the window in question, selects the highest value of D_{R} as the value of D_{R} resulting from application of the terms offered by the organization to that customer, and thus selects the particular constituent strategy associated with that highest value. If the resulting value is higher than the values for competing organizations, the system increments the revenue tally and any tally associated with a capacity-limited element of value (e.g., a tally of aisle seats sold) accordingly. This implementation simulates the behavior of customers reacting to multiple different terms offered in a menu.

Each of the constituent strategies may incorporate rules for adjusting terms offered to customers which rules may be different than the rules of other constituent strategies. The ability of the system to simulate multiple constituent strategies allows an organization such as an airline to accurately predict results arising from fine segmentation of the market.

In a further variant, the system can simulate the possibility that one or more competitive organizations will change its strategy. For example, the user may supply multiple external strategies for one or more competitive organizations, each associated with a probability that the competitive organization will adopt such strategy. A given internal strategy can be run against each possible combination of external strategies adopted by competitive organizations, and the result can be associated with the probability that such combination of external strategies will actually be adopted by the competitive organizations. Thus, each internal strategy is associated with a measure of probability that the predicted result can be achieved, and the probability of deviant financial results arising from differing market responses of competitors. For example, assuming that there is only one competitive organization with an 80% probability that the competitive organization will adopt strategy 1A, and a 20% probability that the competitive organization will adopt strategy 1B. Further, assume that the first organization may adopt internal strategy A or internal strategy B. The results are shown in Table 1:

TABLE 1

| | | | PROB- |
|---|---|---|---|
| FIRST ORGANIZATION | STRATEGY A | STRATEGY B | ABILITY |
| Competitive Organization 1 | Result = +$10 | Result = +$7 | 80% |
| Strategy 1A | MM CTM | MM CTM | |
| Competitive Organization 1 | Result = −$20 | Result = +$1 | 20% |
| Strategy 1B | MM CTM | MM CTM | |

Strategy A yields 10 million positive CTM run against competitive organization 1A, but a negative $20 million CTM when run against strategy 1B; whereas strategy B yields a positive $7 million CTM run against strategy 1A and a positive $1 million CTM run against strategy 1B. If the step of selecting the best result (step 550) is conducted so as to weight the most positive CTM and also to weight possible negative CTM as a strong negative factor, strategy B will be selected over strategy A.

In yet a further variant, the step of selecting the best result may be performed manually based on output of the results and schedules.

A method according to a further related embodiment of the invention (FIG. 18) is used during actual sales of tickets, after the organization has an selected an internal strategy using the system discussed above, or using another system. The system is supplied with the actual internal strategy which is to be implemented by the organization for a set of trips as, for example, a single flight or a set of flights to a particular destination departing within a relatively brief internal of, for example, a few days. The system is also supplied with possible alternative internal strategies, as well as external strategies being implemented by competitive organizations and customer information as discussed above. In step 603, the system determines the predicted result of implementing the selected strategy against the external strategies. Where the actual strategy was derived from a strategy-selection process using the multi-player game to simulate customer behavior as discussed above with reference to FIG. 15, the step of determining the predicted result may be performed simply by referring to the data compiled during the simulation. Alternatively, if the actual internal strategy being implemented has been selected in some other way, a simulation process similar to that discussed above with respect to FIG. 15 may be performed so as to determine the expected sales of tickets and expected revenue as a function of time during the sales period terminating on the last flight date.

In step 604, the organization implements the actual internal strategy. As the organization sells tickets, it implements the internal strategy by reacting to conditions such as the number of tickets sold, the revenue received, competitive prices, and the like to modify factors such as prices or amenities as dictated by the strategy. As tickets are sold, the system maintains data about the number of tickets sold, revenue received, or other meaningful results. This data may be supplied by a reservations system implemented on a computer system linked to the computer performing the method steps disclosed herein.

At step 606, the system periodically compares the actual results for the set of trips, such as ticket sales or revenue, to the predicted results for the time when the comparison is made. For example, if step 606 is performed on the 50th day of the sale period, 250 days prior to the last flight date, the system will compare actual ticket sales or actual revenue to the predicted revenue for the day 250 days prior to the flight date. If the actual results are within a predetermined tolerance range of the predicted results, the system simply cycles back to step 604 and continues to implement the actual internal strategy provided at step 602. If the results are out of tolerance, the system enters a process of testing various internal strategies to see if any alternate internal strategies may be better. The system may also use a more complex decision tree to determine whether or not to react to an out-of-tolerance condition. For example, the system may compare revenues from ticket sales to date for a particular flight with a first threshold equal to the variable costs of operating the flight and with a second threshold equal to the total costs (variable costs plus allocated overhead) and may choose to leave the existing strategy in place if the first or second threshold has been met. In a further variant, the system may consider the actual revenues realized for a group of trips larger than the set of trips in question. For example, where a set of trips includes a single flight, the system may consider trips in a larger group, such as all flights serving the same route on the same date or within a few days of the flight constituting the set of trips. If the flights in the larger group taken together are above the second threshold (covering fixed and variable costs) the system may decide not to consider alternate strategies.

To the extent not already present in the system, the system gathers actual market information, including factors such as actual prices being charged by competitors, amenities being offered by competitors, and actual sales made by competitors, at step 610. If the external strategies being used by competitors have changed, the new external strategies of the competitive organizations may also be supplied to the system. At step 612, the system selects a possible internal strategy from among the available strategies. These include the actual strategy used up until this point, as well as other possible internal strategies input at step 602. At step 614, the system performs a simulation of the selected internal strategy based on the actual market data, including actual external strategies being applied by competitors. The simulation process desirably includes modeling customer purchase decisions using a multi-player game, with competitors and the first organization reacting to each others actions, in the same manner as discussed above with reference to FIG. 15. However, the initial conditions, such as prices and amenities being offered by the first organization and competitors, are set based on the actual market information. Also, the number of tickets which the first transportation organization can sell is capacity-limited; it is equal to the capacity of the aircraft less the number of tickets already sold for the set of trips. Here again, the simulation yields a predicted final result as of the flight date and also yields predicted results as a function of time, i.e., ticket sales and revenue as a function of days before flight date. At step 618, the system determines whether or not all possible internal strategies (including the actual strategy applied up until this time) have been tested. If not, the system returns to step 612 and selects another possible internal strategy. If all strategies have been simulated, the system selects the internal strategy which yields the best predicted final result, such as maximum revenue, as of the flight date. The selected internal strategy at this point may be the same as the actual strategy used up until this time, or may be a different strategy. The system them returns to step 604 and implements the newly selected internal strategy in actual sales activity.

Methods according to this aspect of the invention can be used to provide intelligent revenue management capabilities heretofore unattainable. In effect, they allow the transportation operation, such an airline, employing these methods to react to developments in the marketplace by changing the rules which it will use in competition. These methods can lead to greatly enhanced profitability. For example, where ticket sales for a particular set of flights are running far ahead of the expected booking curve, the method according to this aspect of the invention may cause the airline using the method to increase pricing and thereby maximize revenue. Desirably, all of the steps referred to in connection with FIG. 18 are performed automatically or with minimal manual input.

In a further variant, the step of testing and selecting a new internal strategy may be performed in response to a change in market information as, for example, information indicating that a competitor has changed its strategy in a material way. In a still further variant, the steps of testing possible internal strategies for a particular set of trips may be performed in reaction to a condition affecting a larger group of trips. For example, if the group consisting of all flights by the first transportation operation to a particular destination as a whole is running behind expected booking, the system may examine alternative strategies for each set of trips within the group.

In yet another variant, one of the internal strategies may include cancellation of the trips in question. The predicted results from such a cancellation would include a penalty associated with loss of customer goodwill. Such penalty may be calculated, for example, based on the number of passengers who have already purchased tickets and who would have to make alternate arrangements, with such penalty increasing substantially as the flight date approaches.

The methods discussed above can be implemented using a general-purchase computer system, such as a computer system having remote communications as discussed above with reference to FIG. 14.

The methods discussed above with reference to FIGS. 15-18 can be used for transportation operations other than airlines. For example, similar methods can be used to plan operations of transportation organizations such as bus lines, railroad lines, and the like selling passenger transportation aboard vehicles, and can also be used to plan the operations of freight transportation operations as well. Also, the methods discussed above with reference to FIG. 18 can be used to manage sale of rights exercisable at specific times as, for example, theater seats, rights to use a parking garage, or other non-transportation operations in which a limited number of rights exercisable at specific times and valueless after those times are sold to customers against competition from competing organizations.

As these and other variations and combinations of the features discussed above can be utilized without departing from the present invention, the foregoing description of the preferred embodiments should be taken by way of illustration rather than by way of limitation of the invention as defined by the claims.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A computer-implemented method of strategic planning for a first transportation organization including:
(a) deriving a set of demographics representing potential sales of transportation by the first transportation organization between origins and destinations using one or more multi-player game models by applying an internal strategy of the first transportation organization and predicted external strategies of one or more competitive organizations to information about the market for transportation between the origins and destinations, at least one of the strategies including responses to one or more market conditions;
(b) developing a feasible schedule for transportation based on the demographics derived in step (a) and at least one set of resources associated with the first transportation organization whereby the schedule is associated with the internal strategy used in step (a);
(c) evaluating a result set for the schedule developed in step (b) whereby the result set is associated with the internal strategy used in step (a).

2. A method as claimed in claim 1 further comprising the steps of:
(d) repeating steps (a), (b), and (c) using a plurality of different internal strategies; and
(e) selecting the internal strategy associated with the best result set.

3. A method as claimed in claim 1 wherein at least one of the predicted external strategies include responses limited by estimated capacities of one or more competitive organizations.

4. A method as claimed in claim 1 wherein at least one of the strategies includes prices charged for transportation and rules for adjusting such prices responsive to at least one market condition.

5. A method as claimed in claim 4 wherein at least one of the strategies includes rules for adjusting prices charged for transportation by the organization using the strategy responsive at least in part to quantities of transportation sold by the organization using the strategy.

6. A method as claimed in claim 4 wherein at least one of the strategies includes rules for adjusting prices charged for transportation by the organization using the strategy responsive at least in part to prices charged for transportation by organizations other than the organization using the strategy.

7. A method as claimed in claim 1 wherein one or more of the strategies includes information specifying one or more elements of value associated with transportation.

8. A method as claimed in claim 1 wherein one or more of the internal strategies includes information specifying one or more elements of value associated with transportation and rules for adjusting such elements of value responsive to at least one market condition.

9. A method as claimed in claim 1 wherein at least one of the strategies includes a plurality of constituent strategies and the step of deriving demands includes applying different ones of the constituent strategies to different portions of the market.

10. A method as claimed in claim 9 wherein the step of deriving demographics includes applying different ones of the constituent strategies to different sets of origins and destinations.

11. A method as claimed in claim 1 wherein the step of deriving demographics includes simulating behavior of a plurality of simulated customers making a plurality of simulated purchases of transportation at different times and assigning each such simulated purchase to one of the organizations.

12. A method as claimed in claim 11 wherein the step of assigning each simulated purchase to one of the organizations includes simulating an interaction between characteristics of the simulated purchaser and terms for transportation offered by each organization according to the strategy used by that organization.

13. A method as claimed in claim 12 wherein the step of simulating an interaction is performed using different characteristics for different simulated purchasers.

14. A method as claimed in claim 2 further comprising the step of having the first organization implement the selected internal strategy in sales of transportation and operate trips according to the schedule associated with that strategy.

15. A method as claimed in claim 14 wherein the step of implementing the strategy includes applying the strategy to real data and controlling at least one of sales of transportation, prices charged for transportation and elements of value associated with transportation at least in part according to the results of such application.

16. A method as claimed in claim 15 wherein the real data includes actual sales of capacity in such set of operations.

17. A method as claimed in claim 15 wherein the real data includes actual prices charged by competitive organizations.

18. A method as claimed in claim 15 further comprising the steps of:
(a) during sales of transportation aboard a set of trips, comparing one or more result parameters for the set of trips related to actual sales to a prediction of the one or more result parameters for that set of trips; and, if the one or more result parameters varies from the prediction;
(b) obtaining at least one new prediction of the one or more result parameters by applying one or more possible internal strategies of the first transportation organization and predicted external strategies of one or more competitive organizations to information about the market for transportation aboard the trips in the set;
(c) selecting a new internal strategy based on the one or more predictions from step (b); and then
(d) implementing the new internal strategy with respect to the set of trips.

19. A method as claimed in claim 18 wherein the prediction is a prediction of the one or more result parameters as a function of time remaining until the trips in the set.

20. A method as claimed in claim 15 wherein the one or more result parameters include sales revenue for transportation aboard the set of trips.

21. A method as claimed in claim 18 wherein each set of trips includes one trip.

22. A method as claimed in claim 1 wherein the step of evaluating a result set includes calculating a nominal financial result.

23. A method as claimed in claim 22 wherein the step of evaluating a result set includes calculating one or more deviant financial results and a probability associated with each such deviant financial result.

24. A method as claimed in claim 23 wherein the step of calculating one or more deviant financial results includes calculating one or more financial results arising from market responses of one or more competitors differing from the predicted market responses of such competitors.

25. A method as claimed in claim 23 wherein the step of evaluating a result set includes evaluating a combination of the nominal financial result and a measure of risk based on the one or more deviant financial results and the probabilities associated therewith.

26. A method as claimed in claim 1 wherein the first transportation organization is a passenger airline.

27. A method of revenue management for a first organization offering rights associated with specific times comprising:
(a) selling rights associated with a set of specific times and controlling terms of sale according to an original internal strategy; and,
in response to a condition occurring during step (a):
(b) using a computer, obtaining at least one new prediction of one or more result parameters using a multi-player game model by applying one or more possible internal strategies and predicted external strategies of one or more competitive organizations to information about the market, at least one of the strategies including responses to one or more market conditions;
(c) using a computer, selecting a new internal strategy based on the at least one prediction from step (c); and then
(d) implementing the new internal strategy with respect to the sale of rights associated with the set of times.

28. A method as claimed in claim 27 further comprising the step of comparing one or more result parameters related to actual sales to a prediction of the one or more result parameters for the set of times; and wherein the condition include one or more of the result parameters varying from the prediction by more than a tolerance amount.

29. A method as claimed in claim 27 wherein the prediction is a prediction of the one or more result parameters as a function of time remaining until the set of times.

30. A method as claimed in claim 27 wherein the one or more result parameters include sales revenue for rights associated with the set of times.

31. A method as claimed in claim 27 wherein the one or more result parameters include an amount of rights sold.

32. A method as claimed in claim 27 wherein at least one of the strategies includes prices charged for rights and rules for adjusting such prices responsive to at least one market condition.

33. A method as claimed in claim 32 wherein at least one of the strategies includes rules for adjusting prices charged for rights by the organization using the strategy responsive at least in part to the amount of rights sold by the organization using the strategy.

34. A method as claimed in claim 32 wherein at least one of the strategies includes rules for adjusting prices charged for rights by the organization using the strategy responsive at least in part to prices charged for rights by organizations other than the organization using the strategy.

35. A method as claimed in claim 27 wherein the rights are rights to passenger transportation aboard vehicles.

36. A method as claimed in claim 35 wherein one or more of the strategies includes information specifying one or more elements of value associated with transportation.

37. A method as claimed in claim 35 wherein one or more of the internal strategies includes information specifying one or more elements of value associated with transportation and rules for adjusting such elements of value responsive to at least one market condition.

38. A planning system for a transportation organization, comprising:
a) at least one input node operable to receive input information;
b) a computer connected to the at least one input node so that input information received by the input node will be supplied to the computer, the computer being operable in response to the input information to:
(1) derive a set of demographics representing potential sales of transportation by the first transportation organization between origins and destinations using one or more multi-player game models by applying an internal strategy of the first transportation organization and predicted external strategies of one or more competitive organizations to information about the market for transportation between the origins and destinations, at least one of the strategies including responses to one or more market conditions;
(2) develop a feasible schedule for transportation based on the demographics derived in step (1) and at least one set of resources associated with the first transportation organization whereby the schedule is associated with the internal strategy used in step (1);
(3) evaluate a result set for the schedule developed in step (2) whereby the result set is associated with the internal strategy used in step (a).
(4) repeat steps (1), (2), and (3) using a plurality of different internal strategies; and
(5) select the internal strategy associated with the best result set.

39. A system as claimed in claim 38 wherein the computer is connected with at least one output node and the at least one input node through an electronic communications network, and wherein the computer is operable to output an indication of the selected strategy to the at least one output node.

40. A revenue management system for an organization, comprising:
a) at least one input node operable to receive input information;
b) a computer connected to the at least one input node so that input information received by the input node will be supplied to the computer, the computer being operable in response to the input information to:
(1) control terms of sale for rights associated with a set of specific times according to an original internal strategy; and,
in response to a condition occurring during step (1):
(2) obtain at least one new prediction of one or more result parameters using a multi-player game model by applying one or more possible internal strategies and predicted external strategies of one or more competitive organizations to information about the market, at least one of the strategies including responses to one or more market conditions;
(3) select a new internal strategy based on the at least one prediction from step (2); and then
(4) implement the new internal strategy with respect to the sale of rights associated with the set of times.

41. A transportation system comprising:
a) a plurality of vehicles;
b) a plurality of terminal locations;
c) at least one input node operable to receive input information;
d) a computer connected to the at least one input node so that input information received by the input node will be supplied to the computer, the computer being operable in response to the input information to perform a process as claimed in claim 1 or claim 27 and
e) at least one output node disposed at one or more of the terminal locations and connected to the computer so that output information representing results of the process will be supplied to the at least one output node.

42. A transportation system as claimed in claim 41 wherein the vehicles include airplanes and the terminal locations include airports.

43. A programming element for a computer comprising a computer-readable medium having a program stored thereon, the program being operative to cause a computer to perform a method as claimed in claim 1 or claim 27.
